(19) United States
(12) Patent Application Publication
(10) Pub. No.: US 2005/0262572 A1
(43) Pub. Date: Nov. 24, 2005

(54) Information processing apparatus, operation permission/ denial information generating method, operation permission/denial information generating program and computer readable information recording medium

(76) Inventor: Miki Yoneyama, Tokyo (JP)

Correspondence Address: DICKSTEIN SHAPIRO MORIN & OSHINSKY LLP, 2101 L Street, NW, Washington, DC, 20037, US

(21) Appl. No.: 11/100,636

(22) Filed: Apr. 7, 2005

(30) Foreign Application Priority Data
Apr. 8, 2004 (JP) 2004-114373

(51) Int. Cl. H04L 9/00; H04L 9/32; G06F 11/30; G06F 12/14

(52) U.S. Cl. 726/27; 713/189

(57) ABSTRACT

An operation permission/denial information generating part carries out permission/denial determination for operation of one actor on one resource for each type of operation based on resource classification information classifies each resource to be operated, actor classification information classifies each actor who operates the resource and definition information defining rules concerning permission/denial determination on the operation for each type of operation corresponding to combinations between the resource classifications and the actor classifications; and generates operation permission/denial information indicating permission/denial for each type of the operation based on thus-obtained permission/denial determination result.

### BACKGROUND OF THE INVENTION

1. Field of the Invention

The present invention relates to an information processing apparatus, an operation permission/denial information generating method, an operation permission/denial information generating program and a computer readable information recording medium, and, in particular, to an information processing apparatus, an operation permission/denial information generating method, an operation permission/denial information generating program and a computer readable information recording medium for providing information concerning an operation right for a resource.

2. Description of the Related Art

In a computer system, an access right is commonly defined for each resource for the purpose of avoiding unauthorized access thereto (see Japanese Laid-open Patent Application No. 2000-231509, for example). Data defining such an access right is commonly called an ACL (access control list). FIG. 1 shows a concept of the ACL for a document management system. In the ACL shown, permission/denial of reference, perusal, updating, deletion and so forth on a document is defined for each user or group. In the document management system, such an ACL is defined for each document, and thus, protection of the documents is aimed.

When such operation right information for each document is managed, the information can be provided to a user who requests for perusal of the operation right information for any document, in a manner such that the information is easily understandable, as a result of the contents of the ACL for the documents being displayed as they are.

On the other hand, there is a system in which operation right information held for each of various systems is managed unitarily by a specific server together with various types of security information (such a server will be referred to as a ‘security server’, hereinafter), and thereby, a common security rule can be applied to access control on resources in the plurality of systems. Information managed by the security server is commonly called a ‘security policy’.

### SUMMARY OF THE INVENTION

However, since the security policy is applied to a plurality of system in common, the contents defined there are commonly those in an abstract expression from which specific processing contents cannot be recognized directly. For example, although an actual meaning of an obligation applied when printing operation is permitted is ‘tint block print’, a definition is made in the security policy in an expression such as ‘copy restraint’, or such. Further, unlike the ACL, the operation right information in the security policy is not set for each particular resource (document or such) but is commonly defined for each combination between a classification of an actor (user or group) who actually operates a resource and a classification of the resource.

Accordingly, even when the definition contents of the security policy which are in an abstract expression and also have various types of combinations as mentioned above are displayed as they are, a user may feel troublesome for finally understanding therefrom his or her own operation right on a specific document.

The present invention has been devised in consideration of such a problem, and an object of the present invention is to provide an information processing apparatus, an operation permission/denial information generating method, an operation permission/denial information generating program and a computer readable information recording medium, by which information concerning operation rights on resources can be provided appropriately.

In order to solve the above-mentioned problem, according to the present invention, an operation permission/denial information generating part is provided which carries out permission/denial determination for operation of one actor on one resource for each type of operation based on resource classification information classifying each resource to be operated, actor classification information classifying each actor who operates the resource and definition information defining rules concerning permission/denial determination on the operation for each type of operation corresponding to combinations between the resource classifications and the actor classifications; and generates operation permission/denial information indicating permission/denial for each type of the operation based on thus-obtained permission/denial determination result.

In an information processing apparatus having such a configuration, it is possible to provide information indicating whether or not each type of operation right is given to one user for one resource, for a case where operation rights on resources are managed by a plurality of sets of security information including resource classification information, actor classification information and definition information.

Further, in order to solve the above-mentioned problem, the present invention may be embodied in a form of an operation permission/denial information generating method executed in the above-mentioned information processing apparatus, an operation permission/denial information generating program for causing the information processing apparatus to execute the operation permission/denial information generating method, or a computer readable information recording medium recording the operation permission/denial information generating program.

According to the present invention, it is possible to provide an information processing apparatus, an operation permission/denial information generating method, an operation permission/denial information generating program and a computer readable information recording medium, by which information concerning operation rights on resources can be provided appropriately.

### BRIEF DESCRIPTION OF THE DRAWINGS

Other objects and further features of the present invention will become more apparent from the following detailed description when read in conjunction with the accompanying drawings:

FIG. 1 shows a conceptual diagram of an ACL in a document management system;

FIG. 2 shows a configuration example of a document management system in an embodiment of the present invention;

FIG. 3 shows a hardware configuration example of a security management server in the embodiment of the present invention;

FIG. 4 shows a functional configuration example of an operation right information display function in the document management system in the embodiment of the present invention;

FIG. 5 shows an example of a user profile;

FIG. 6 shows an example of a document profile;

FIGS. 7 through 9 show examples of policy definitions;

FIG. 10 shows a conceptual diagram of policy definition contents;

FIG. 11 shows a configuration example of a permit management table;

FIGS. 12 and 13 shows a sequence diagram illustrating processing carried out when an operation right perusal page is displayed;

FIG. 14 shows a conceptual diagram of an access mask;

FIG. 15 shows a display example of the operation right perusal page;

FIG. 16 shows a flow chart illustrating an outline of access mask generating processing carried out by an access mask generating module;

FIG. 17 shows a flow chart illustrating processing generating an access mask based on a policy;

FIG. 18 shows a configuration example of a mapping table;

FIG. 19 shows an example of the access mask reflecting a definition set on one operation;

FIG. 20 shows an example of the access mask generated by the processing of FIG. 17;

FIG. 21 shows a flow chart illustrating processing for reflecting the contents of a permit in the access mask;

FIG. 22 shows an example of the access mark reflecting the contents of the permit;

FIG. 23 shows a flow chart illustrating processing for extracting applying rule information carried out by an applying rule information extracting module;

FIG. 24 shows a flow chart illustrating processing for extracting the applying rule information from the policy;

FIG. 25 shows a configuration example of the applying rule information extracted;

FIG. 26 shows a flow chart illustrating applying permit extracting processing;

FIG. 27 shows one example of the permit extracted;

FIG. 28 shows a flow chart illustrating processing for extracting the applying rule information for current operation;

FIG. 29 shows an example of the applying rule information for the current operation;

FIG. 30 shows a flow chart illustrating processing for extracting the applying permit for the current operation;

FIG. 31 shows an example of the operation right perusal page for a case where printing operation is selected;

FIG. 32 shows a display example of the operation right perusal page displaying an operation right for a user C on a document 4; and

FIG. 33 shows a display example of the operation right perusal page displaying an operation right for a user A on the document 4.

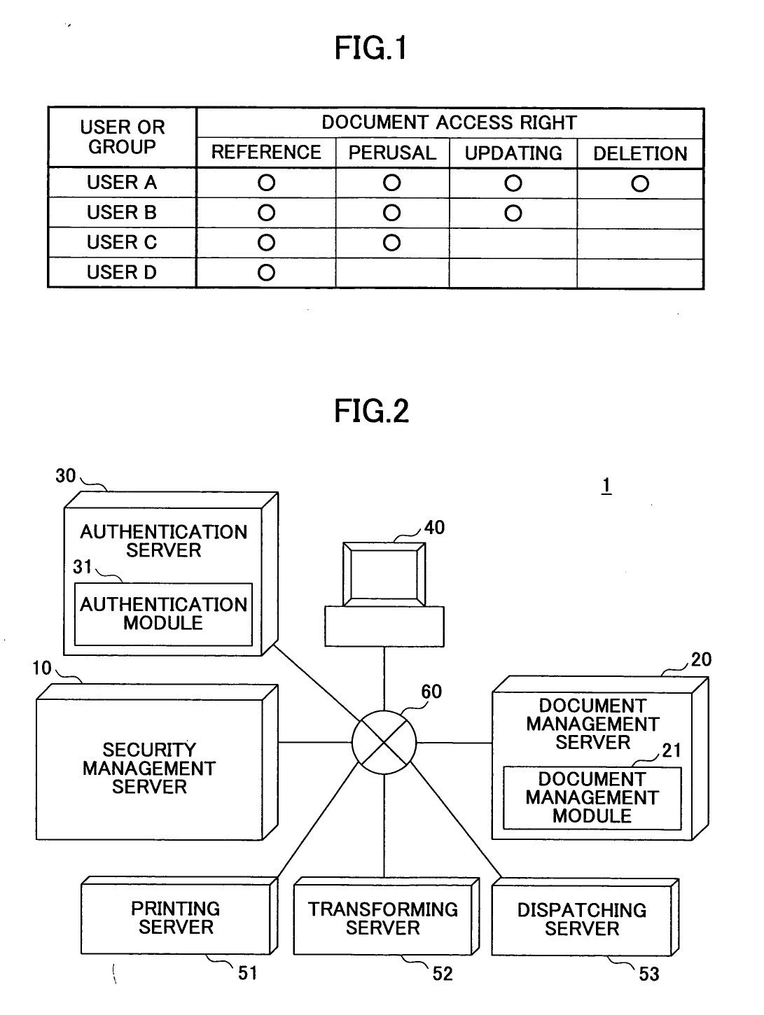

### DETAILED DESCRIPTION OF THE PREFERRED EMBODIMENT

FIG. 2 shows a configuration example of a document management system in one embodiment of the present invention. As shown, the document management system 1 in the embodiment includes a security management server 10, a document management server 20, an authentication server 30, a client apparatus 40, a printing server 51, a transforming server 52 and a dispatching server 53 which are connected mutually via a communication network 60 such as the Internet, LAN (local area network) or such.

The security server 10 is a computer carrying out management of various types of information (referred to as ‘security information’, hereinafter) concerning security. Various types of servers (the document management server 10, the printing server 51, the transforming server 52 and the dispatching server 53) which handle documents in this document management system determine, based on the security information managed by the security management server 10, whether or not each user has an operation right on the document.

The document management server 20 is a computer in which a document management module 21 is mounted which carries out document management (storage of documents, search, updating or deletion of the stored documents, or such).

The authentication server 30 has an authentication module 31 mounted therein which carries out authentication of a user of the document management system 1. The authentication module 31 caries out authentication of the user in response to an authentication request, and, issues an electronic certificate (refereed to as a ‘ticket’, hereinafter) proving that the user has been authenticated properly when the user is authenticated properly.

The printing server 51, the transforming server 52 and the dispatching server 53 are examples of various servers handling documents managed by the document management server 20. The printing server 51 is a computer in which a function is mounted for causing a document to be printed out by means of a printer. The transforming server 52 is a computer in which a function is mounted for transforming a given document into a predetermined data format. The dispatching server 53 is a computer in which a function is mounted for dispatching a given document to a predetermined destination.

The client apparatus 40 is a computer in which an application is mounted which uses the above-mentioned functions of the various servers. The client apparatus 40 may not be necessarily a computer which a user directly uses. For example, the client apparatus 40 may be a Web server. In this case, the application mounted in the client apparatus 40 corresponds to a Web application.

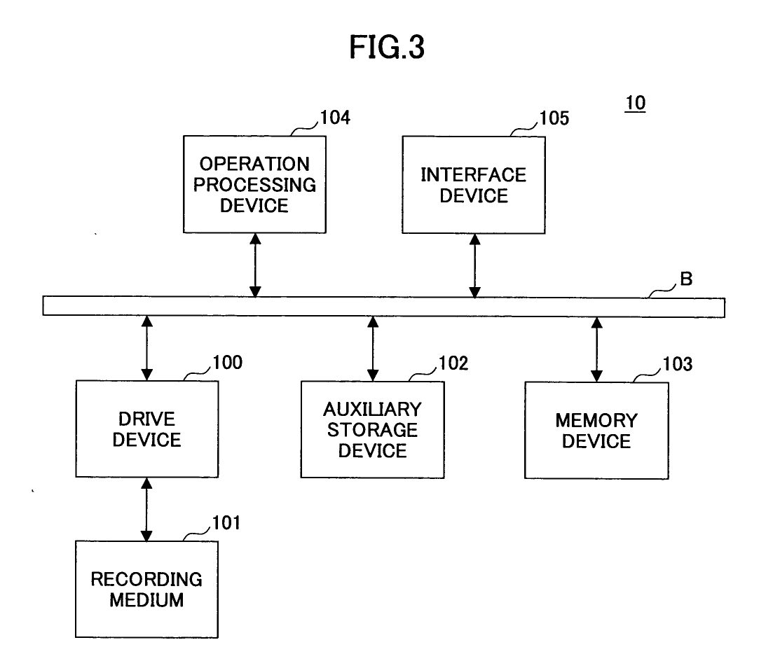

The security management server 10 is described next in detail. FIG. 3 shows a hardware configuration example of the security management server 10 in the embodiment of the present invention. This security management server 10 includes a drive device 100, an auxiliary storage device 102, a memory device 103, an operation processing device 104 and an interface device 105, which are mutually connected by a bus B.

A program for performing processing in the security management server 10 is provided by a recording medium 101 such as a CD-ROM. When the recording medium 101 recording the program is set in the drive device 100, the program is installed in the auxiliary storage device 102 from the recording medium 101 via the drive device 100.

The auxiliary storage device 102 stores the installed program, and also, stores necessary files and data. The memory device 103 stores the program read out from the auxiliary storage device 102 when a starting up instruction for the program is given. The operation processing device 104 carries out functions concerning the security management server 10 according to the program stored in the memory device 103. The interface device 105 includes, for example, a modem, a router or such, and is used for connecting to the network 60 shown in FIG. 2.

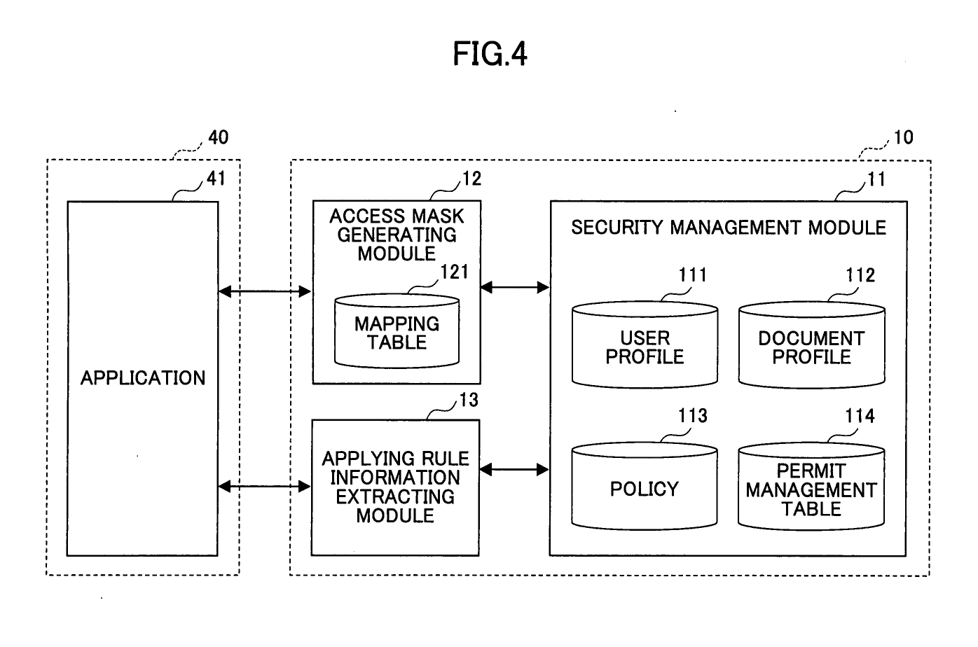

FIG. 4 shows a functional configuration example relating to an operation right information display function in the document management system in the embodiment of the present invention. As shown, in the security management server 10, a security management module 11, an access mask generating module 12 and an applying rule information extracting module 13 are mounted. The security management module 11 has a function mounted therein for managing various types of security information. The security management module 11 manages, as the security information, a user profile 111, a document profile 112, a policy 113 and a permit management table 114.

FIG. 5 shows an example of the user profile. As shown, the user profile 111 includes information classifying each user according to whether or not the user is a person concerting any division, and defines, for each user, whether or not the user is a person concerning each division (a division A, a division B and a division C). For example, in the profile 111, it is defined that a user A is a person concerning the division A, but is neither a person concerning the division B nor a person concerning the division C. A ‘person concerning a division’ means that the person who belongs to the division, the person participates a project of the division, or such.

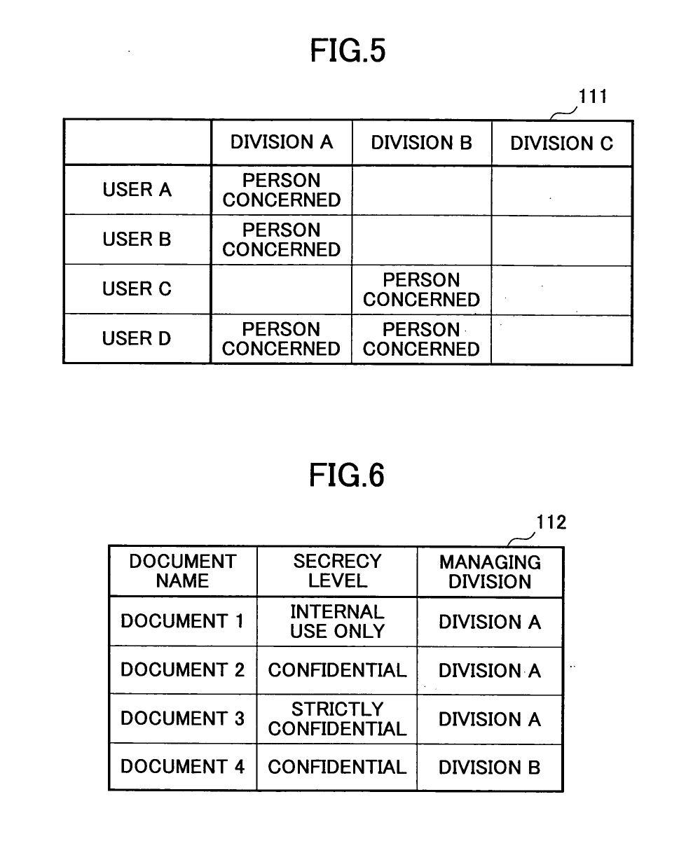

FIG. 6 shows an example of the document profile. As shown, the document profile 112 includes information classifying each document according to its secrecy level or such, and defines a document name, a secrecy level, a managing division or such for each document. The document name is a name given to the document. The secrecy level is a secrecy degree of the document. The managing division is a name of a division which manages the document. For example, in the document profile 112, a document 1 is a document for internal use only, and managed by a division A.

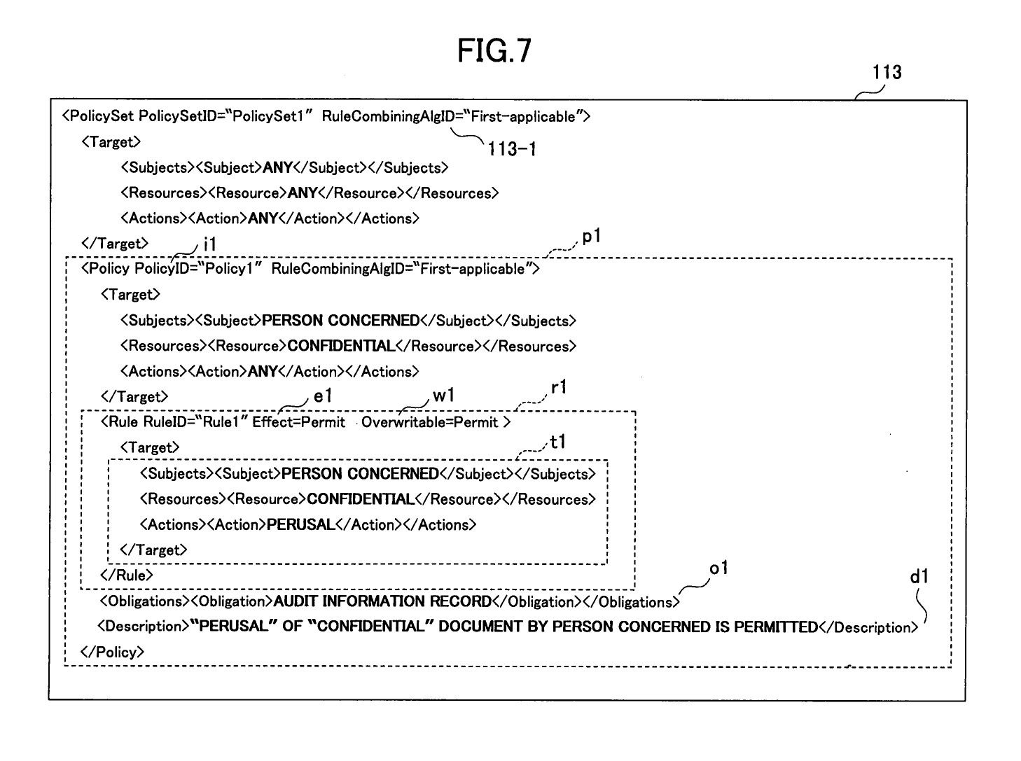

FIGS. 7 through 9 show policy definition examples. This policy 113 is defined with reference to a specification of XACML (extensible access control markup language). The reason why the expression ‘with reference to’ is used is that, basically the definition is made according to the specification of XACML. However, also, unique extension is made in the embodiment. FIGS. 7-9 are shown in a separate form for the purpose of easily understanding, but correspond to definitions included in a single file.

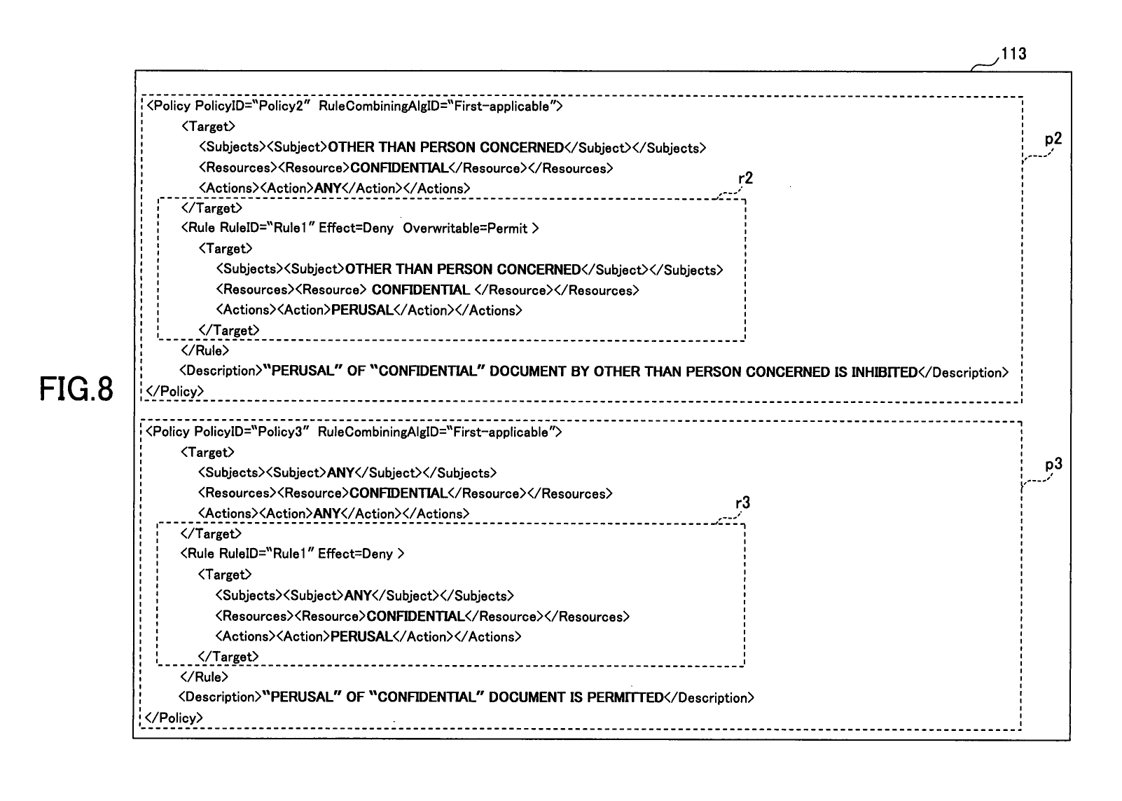

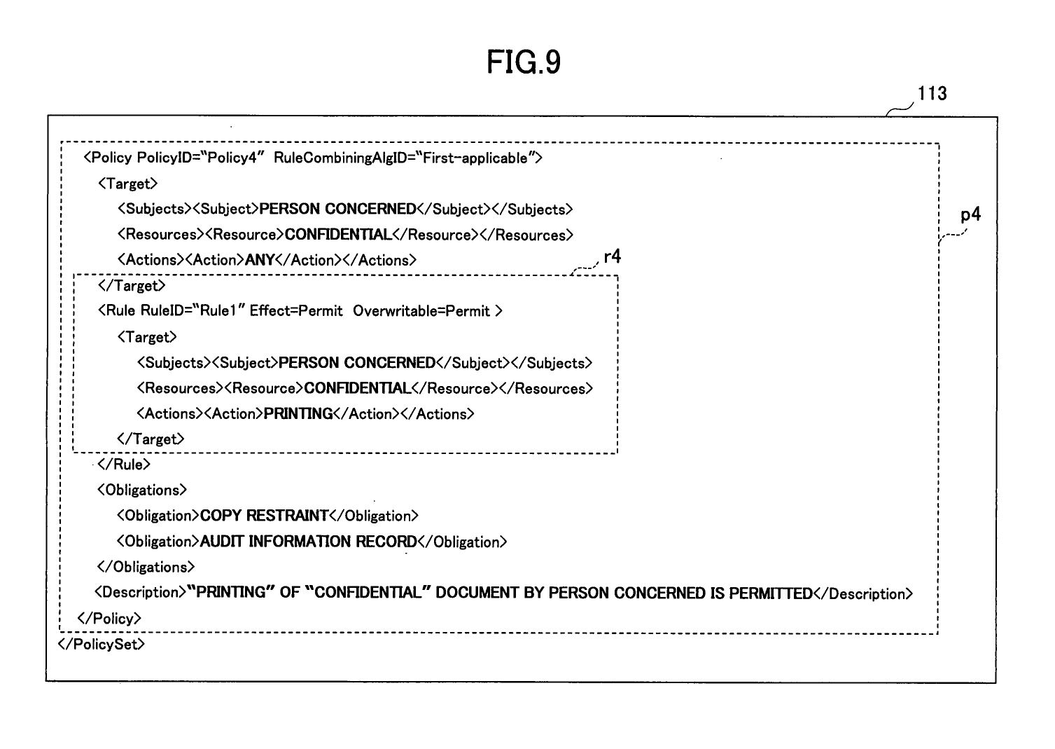

In the policy 113, a rule (security rule) is defined for each combination of an actor (user), a resource (document) and a type of operation, for determining whether or not the operation is permitted. A Rule definition enclosed by <Rule> tags corresponds to a definition corresponding to one security rule. The figures include a Rule definition r1 (FIG. 7), a Rule definition r2, a Rule definition r3 (FIG. 8), a Rule definition r4 (FIG. 9) and so forth. Each Rule definition includes, as an element, a Target definition enclosed by <Target> tags. For example, the Rule definition r1 includes a Target definition t1.

The target definition is a definition for specifying objects (actor, resource and a type of operation) to which the security rule is applied, and includes a Subject definition enclosed by <Subject(s)> tags, a Resource definition enclosed by <Resource(s)> tags, and an Action definition enclosed by <Action(s)> tags. The Subject definition is a definition specifying a classification of an actor to which the security rule is applied. The Resource definition is a definition specifying a classification of a resource to which the security rule is applied. The Action definition is a definition specifying a type of operation to which the security rule is applied. For example, by the Target definition t1, it is specified that this definition defines the security rule to be applied when it is determined whether or not perusal (operation) by a person (actor) concerning a confidential document (resource) is permitted.

A determination value obtained when the security rule is applied is specified by a value of an Effect attribute of the relevant Rule definition. That is, when the value of the Effect attribute is ‘Permit’, the determination value becomes ‘permission’, while, when the same is ‘Deny’, the determination value becomes ‘denial’. For example, since the value of the Effect attribute e1 of the Rule definition r1 is ‘Permit’, the determination value obtained when this Rule definition r1 is applied becomes ‘permission’. Accordingly, the Rule definition r1 defines that ‘perusal of a confidential document by a person concerned is permitted’.

An Overwritable attribute is also defined in the Rule definition. The Overwritable attribute is an attribute for determining whether or not overwriting with a definition by a permit (described later) is permitted. For example, a value of the Overwritable attribute w1 in the Rule definition r1 is ‘Permit’. This means that overwriting by the permit is permitted for the Rule definition r1.

One or a plurality of Rule definitions can be integrated by means of a Policy definition enclosed by <Policy> tags. In the figures, a Policy definition p1 (FIG. 7), a Policy definition p2, a Policy definition p3 (FIG. 8) and a Policy definition p4 (FIG. 9) are shown. Each Policy definition may include an Obligation definition enclosed by <Obligation> tags, a Description definition enclosed by <Description> tags, and so forth. For example, the policy definition p1 includes the Obligation definition o1 and the Description definition d1, as shown.

The Obligation definition is a definition for defining an obligation placed on a user when access to a resource is permitted for the user, and is applied to all the Rule definitions belonging to the Policy definition including the relevant Obligation definition in common. However, in the present embodiment, the Policy definition and the Rule definition are in a one-to-one correspondence. This is because, the Obligation definition is preferably defined for each Rule definition in the present embodiment, while, according to the XACML speciation, the Obligation definition is defined for each Policy definition. In the Obligation definition dl, recording of audit information (AUDIT INFORMATION RECORD) is prescribed as the obligation. Thus, the Policy definition p1 defines that ‘perusal of a confidential document by a person concerned is permitted, however, when perusal is made, the user should record audit information’.

The Description definition is a definition in which a statement describing the contents of the Rule definition in the Policy definition is defined. The statement (referred to as a ‘definition content statement’ hereinafter) in the Description definition is utilized as a letter string to be displayed, as described below.

The Policy definition further defines a Policy ID attribute. The Policy ID attribute is an ID for uniquely identifying each Policy definition. For example, a value of the Policy ID attribute i1 of the Policy definition p1 is defined as ‘Policy 1’, for example.

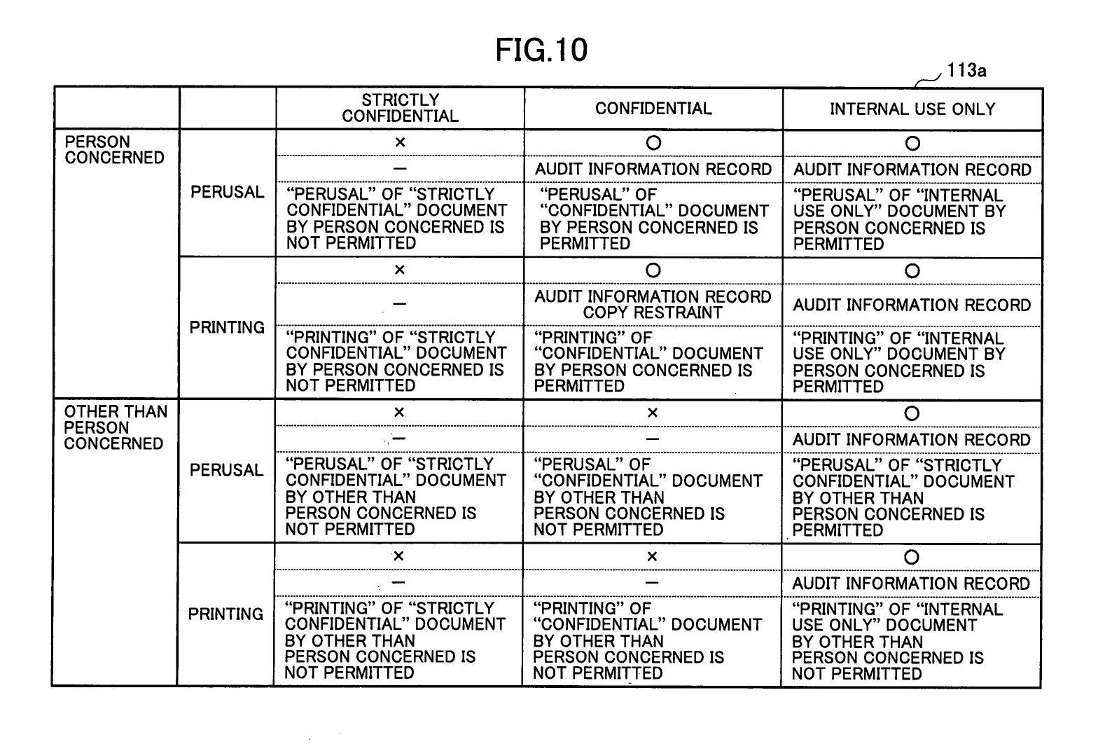

FIG. 10 conceptually shows the policy definition contents. That is, a table 113a shows the definition contents derived from the description of the policy 113 shown in FIGS. 7-9 collectively in a form of the table. As shown, it is seen that, corresponding to each combination between an actor's classification (a person concerning a document or a person not concerning the document) and a document's classification (strictly confidential, confidential, or internal use only), permission/denial (O or X) for each type of operation (perusal or printing), an obligation and a definition content statement are defined in the description of the policy 113.

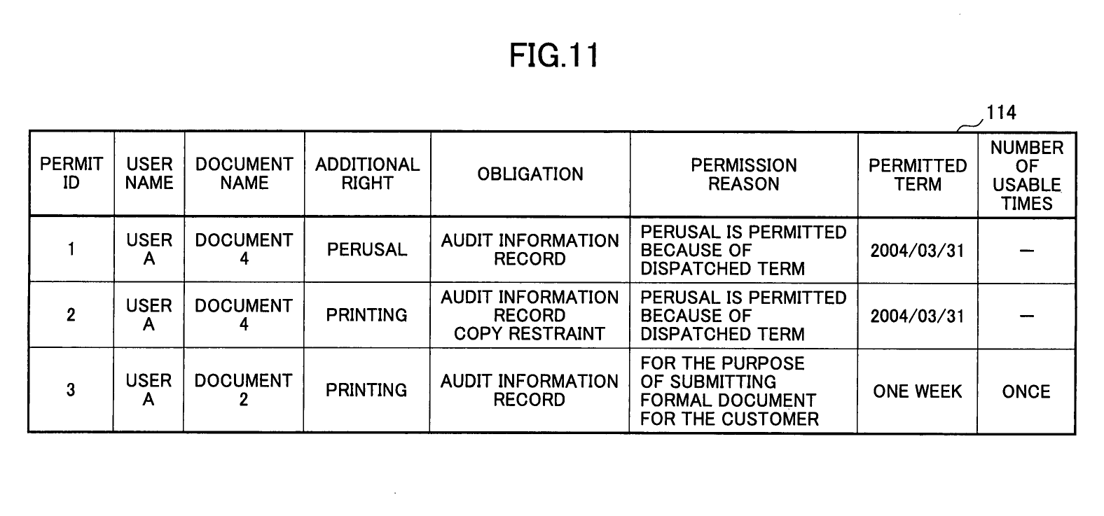

FIG. 11 shows a configuration example of a permit management table. The permit management table 114 is a table for managing permits where each record of the permit management table 114 corresponds to a respective permit. The permit is information defining an additional right which cannot be defined within the policy 113, and includes a permit ID, a user name, a document name, an additional right, an obligation, a permission reason and a number of usable times. The permit ID is an ID for identifying each permit. The user name is a name of a user to which the permit is applied. The document name is a name of a document to which the permit is applied. The additional right is an operation right additionally permitted by the permit. The obligation is an obligation placed on the user when the additional right is permitted for the user. The permission reason is a letter string describing a reason why the permit is issued in a form recognizable by the user. The permitted term is a valid term of the permit. The number of usable times is a number of times of usage for which the permit is effective. In FIG. 11, information for three permits is shown. By the permit having the permit ID of ‘1’, a user A's perusal of a document A is permitted. However, when the user A actually peruses the document A, audit information should be recorded. Further, this operation is permitted until Mar. 31, 2004. By the permit, it is possible to temporarily give a user a specific right for a case where, for example, the user, who has no right in the policy 113, temporarily participates a predetermined project.

Returning to FIG. 4, the access mask generating module 12 is a module in which a function is mounted for carrying out permission/denial determination on each type of operation for an arbitrary document by an arbitrary user based on the various types of security information described above, and generating data (referred to as an ‘access mask’, hereinafter) indicating the determination result. The access mask generating module has a mapping table 121, which will be described later.

The applying rule information extracting module 13 is a module in which a function is mounted for extracting information (applying rule information) concerning the security rule to be applied to each type of operation for an arbitrary document by an arbitrary user from the policy 113, and also, extracting, from the permit management table 114, a permit issued for the combination between the user and the document.

The application 41 in the client apparatus 40 is an application for displaying a page (referred to as an ‘operation right perusal page’, hereinafter) showing the access mask generated by the access mask generating module 12, the applying rule information extracted by the applying rule information extracting module 13, and so forth, for the user.

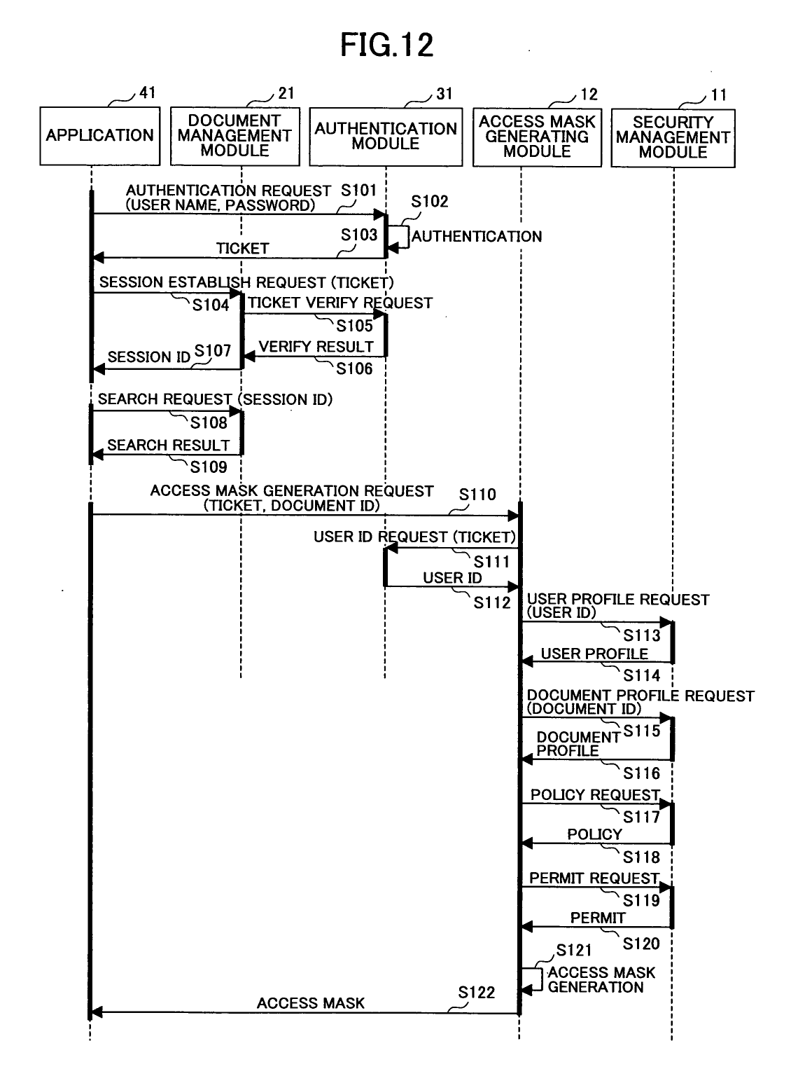

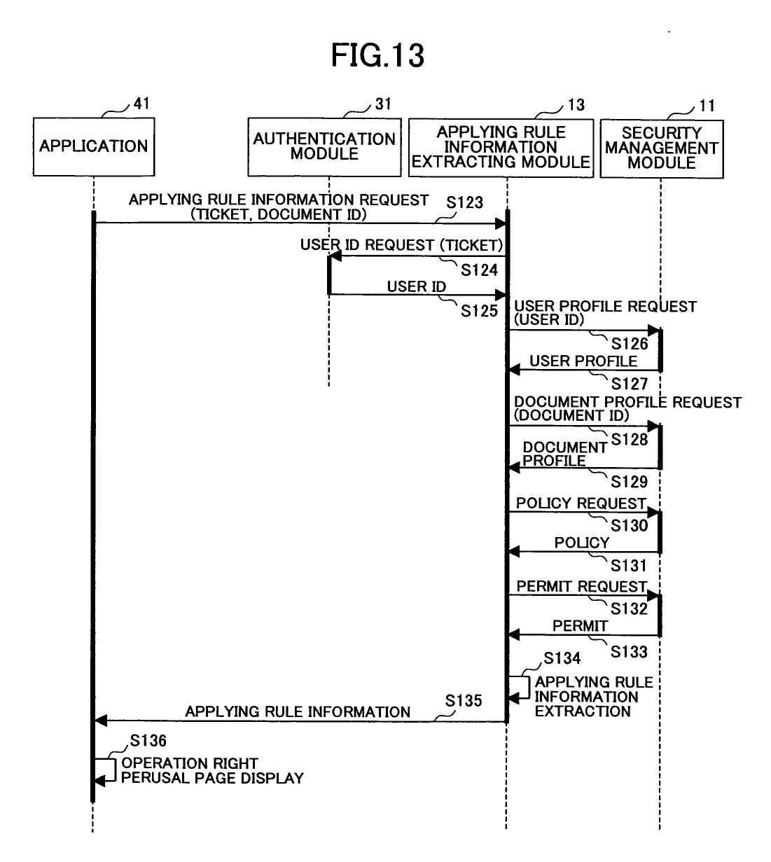

Next, a processing procedure in the document management system shown in FIG. 2 is described. FIGS. 12 and 13 show sequence diagrams illustrating processing carried out for displaying the operation right perusal page. FIG. 12 relates to processing of the access mask generating module 12 providing the access mask in response to a request from the application 41. FIG. 13 relates to processing of the applying rule information extracting module 13 providing the applying rule information in response to a request from the application 41.

Steps S101 through S109 correspond to processing (session establishment, document search and so forth) to be carried out before displaying the operation right perusal page. That is, based on logging-in operation by a user, the application 41 requests the authentication module 31 for authentication of the user with a user name and a password as arguments (S101). The authentication module 31 tries to authenticate the user, and, issues a ticket certifying the authentication when the authentication can be made properly (S102). In the ticket, a ticket ID for identifying this ticket, a valid scope indicating an available scope of service allowed by the ticket, a valid term for which the ticket is valid, the user ID, a code for checking for tampering and so forth are recorded. The contents of the ticket are coded in such a manner that only the authentication module 31 can recognize them, and the ticket is transmitted to the application 41 (S103).

The application 41 transmits a session establishment request to the document management module 21 with the received ticket as an argument (S104). The document management module 21 requests the authentication module 31 to prove the propriety of the received ticket (S105). When a proving result indicating the propriety of the ticket is returned (S106), the document management module 21 returns a session ID to the application module 41 (S107). The document module 21 holds the ticket of the user in such a manner that it relates to the session ID.

When the user requests search for a document after establishment of the session, the application 41 transmits a document search request to the document management module 21 with the session ID, search requirements and so forth as arguments (S108). The document management module 21 searches for the document based on the search requirements, and transmits a search result to the application 41 (S109).

At this time, the user is provided with a document list page in which a list of documents thus obtained is displayed. Then, when the user selects a desired document therefrom, and requests a display of the operation right perusal page, the application 41 transmits an access mask generation request to the access mask generating module 12 with a document ID of the thus-selected document (referred to as a ‘current document’, hereinafter) and the ticket as arguments (S110). The document ID and the ticket thus designated as the arguments are significant as information identifying the document or the user for which the access mask is provided.

In Step S111, when the access mask generating module 12 inquires the authentication module 31 for the user ID of the current user with the ticket as an argument, the authentication module 31 obtains the user ID based on the ticket, and transmits the relevant user ID to the access mask generating module 12 (S112).

In Step S113, when the access mask generating module 12 requests the security management module 11 for the user profile concerning the current user from the user profile 111 (FIG. 5), that is, the record (referred to as a ‘current user profile’, hereinafter) of the current user included in the user profile 111 with the user ID as an argument, the security management module 11 obtains the current user profile from the user profile 111, and outputs the same to the access mask generating module 12 (S114).

In Step S115, when the access mask generating module 12 requests the security management module 11 for the document profile of the current document, that is, the record (referred to as a ‘current document profile’, hereinafter) of the current document included in the document profile 112 (FIG. 6), the security management module 11 obtains the current document profile from the document profile 112, and outputs the same to the access mask generating module 12 (S116).

In Step S117, when the access mask module 12 requests the security management module 11 for the policy 113, the security management module 11 outputs the policy 113 to the access mask generating module 12 (S118).

In Step S119, when the access mask generating module 12 requests the security management module 11 for the permit management table 114, the security management module 11 outputs the permit management table 114 (S120).

In Step S121, the access mask generating module 12 carries out permission/denial determination for each type of operation for the current user on the current document based on the current user profile, the current document profile, the policy 113, the permit management table 114 and so forth. Then, based on the determination result, the access mask generating module 21 produces the access mask, and transmits the same to the application 41 (S122).

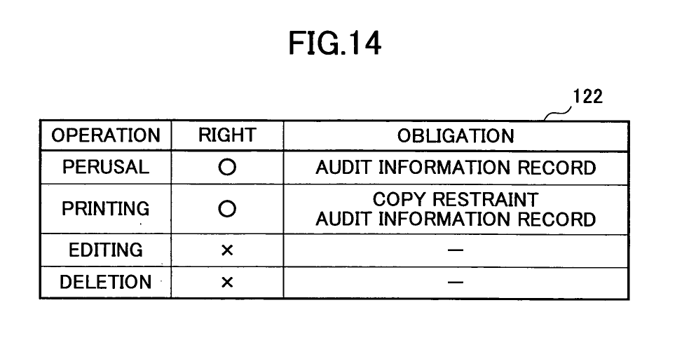

FIG. 14 conceptually shows an example of the access mask. As shown, the access mask includes a permission/denial for a right of one user on one document and an obligation. The access mask 122 shown in FIG. 14 shows a permission/denial of each type of operation for a user A on a document 2. Therefrom, it is seen that perusal and printing by the user A are permitted, and editing and deletion are not permitted. The access mask generating processing in Step S121 is described later in detail.

Then, the application 41 carries out processing for obtaining the applying rule information. That is, in Step S123 (FIG. 13), the application 41 requests the applying rule information extracting module 13 for the applying rule information for the thus-obtained access mask with the ticket and the document ID of the current document as arguments.

The applying rule information extracting module 13 thus having received the request from the application 41 carries out applying rule information extracting processing in the same procedure as that of Steps S111 through S122 carried out by the access mask generating module 12. That is, the user ID of the current user is obtained from the authentication module 31 based on the ticket (S124, S125), and the current user profile is obtained from the security management module 11 based on the user ID (S126, S127). Further, the applying rule information extracting module 13 obtains the current document profile, the policy 113, the permit management table 114 and so forth from the security management module 11, extracting the applying rule information (the policy ID, the definition content statement, the obligation and so forth) from the policy 113 for each type of operation of the current user on the current document based on the current user profile and the current document profile, and extracts the permit from the permit management table 114 issued for the combination between the current user and the current document (S128 through S134). Processing of extracting the applying rule information and so forth in Step S134 is described later in detail.

In Step S135, when the applying rule information extracting module 13 transmits the thus-extracted applying rule information to the application 41, the application 41 generates the operation right perusal page based on the applying rule information and the access mask obtained in Step S122, and displays the thus-generated operation right perusal page (S136).

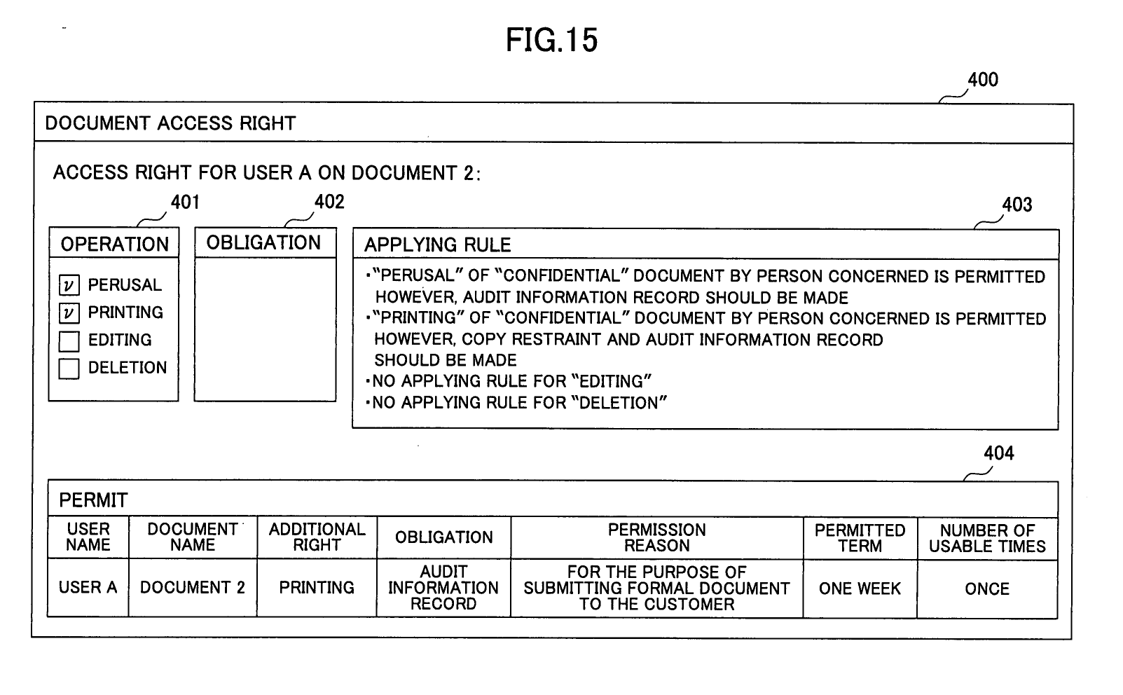

FIG. 15 shows an example of a display of the operation right perusal page. As shown, the operation right perusal page 400 includes an operation right display area 401, an obligation display area 402, an applying rule display area 403, a permit display area 404 and so forth. The operation right display area 401 is an area in which a result of permission/denial for each type of operation is displayed. Types of operation checked there are those finally permitted. In the obligation display area 402, the contents of obligations placed for the types of operation (current operations) selected in the operation right display area 401 are shown. FIG. 15 shows an initial state, no operation is selected yet, and thus, the contents of obligation are not actually displayed there. In the applying rule display area 403, the contents (definition content statements) of the security rules applied for deriving the permission/denial determinations shown in the operation right display area 401 are displayed. In the permit display area 404, the contents of the permit issued for the combination between the current user and the current document are displayed.

The user can instantly understand whether or not an operation right is given, derived from the various types of security information such as the user profile 111, the document profile 112, the policy 113, the permit 114 and so forth, by viewing the operation right display area 401 of the operation right perusal page 400.

In FIGS. 12 and 13, an example is shown in which the application 41 directly transmits a request to the access mask generating module 12 or the applying rule information extracting module 13 for generation of the access mask (S110) or for extraction of the applying rule information (S123). However, alternatively, the document management module 21 may transfer a request or such among the application 41, the access mask generating module 12 and the applying rule information extracting module 13. In this case, in response to a request from the application 41, the document management module 21 transmits the access mask generation request (S110) or the applying rule information extraction request (S123) to the access mask generating module 12 or to the applying rule information extracting module 13. In this case, a destination to which the application 41 sends the requests is limited to only the document management module 12. Accordingly, it is possible to achieve easier mounting of the application 41.

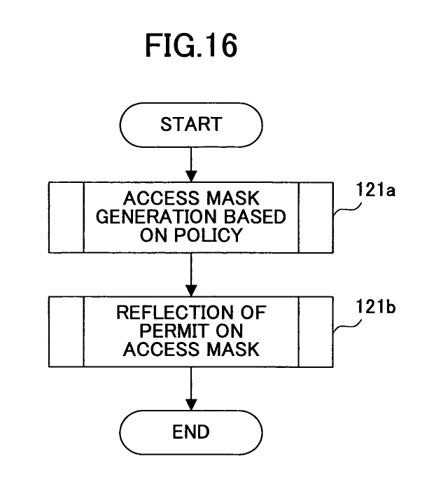

Next, access mask generating processing carried out by the access mask generating module 12 in Step S121 of FIG. 12 is described in detail. FIG. 16 shows a flow chart illustrating an outline of the access mask generating process carried out by the access mask generating module 12. As shown, the access mask generating process generally includes processing (S121a) of generating the access mask according to the policy 112; and processing (S121b) of reflecting the contents of the permit on the access mask generated in Step S121a. Each thereof is described now.

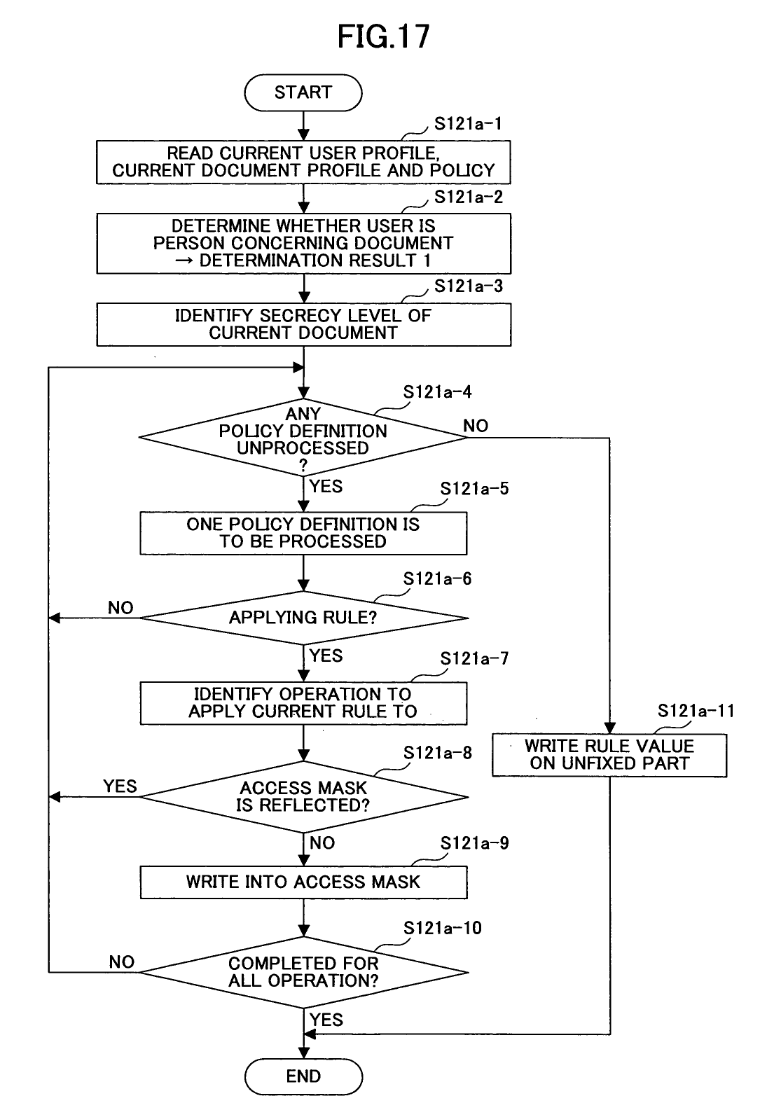

FIG. 17 is a flow chart illustrating the processing of generating the access mask according to the policy 113. FIG. 17 will be described with reference to the definition contents in the policy 113 shown in FIGS. 7 through 9.

In Step S121a-1, the access mask module 12 reads in a memory the current user profile, the current document profile and the policy 113 obtained from the security management module 11. In Step S121a-2, the access mask module 12 determines whether or not the current user is a person concerning the current document. That is, based on the current user profile, the division in which the current user is regarded as a person concerned is identified, and, based on the current document profile, the managing division of the current document is identified. Then, when both divisions are the same as one another, it is determined that the current user is a person concerning the current document. When both are different from one another, it is determined that the current user is a person other than a person concerning the current document. For example, the user A is a person concerning the division A (see FIG. 5), and the managing division of the document 2 is also the division A (see FIG. 6). Therefrom, it is determined that the user A is a person concerning the document 2. This determination result is referred to as a determination result 1, hereinafter. In Step S121a-3, a secrecy level of the current document is obtained based on the current document profile. For example, the secrecy level of the document 2 is obtained as being ‘confidential’.

After that, loop processing is carried out (S121a-4) for each policy definition of the policy 113. First, the access mask generating module 12 obtain L one Policy definition to process from now according to an order defined in the policy 113. Accordingly, first, the Policy definition p1 is determined as an object to be processed now (referred to as a ‘current Policy definition’, hereinafter). In Step S121a-6, the access mask generating module 12 determines whether or not the Rule definition (current Rule definition) included in the current Policy definition is a Rule definition (applying Rule definition) to be applied to the combination between the current user and the current document. That is, if the value of the Subject definition included in the Target definition (referred to as a current Target definition, hereinafter) belonging to the current Rule definition (for example, the Rule definition r1) coincides with the determination result 1, and also, the value of the Resource definition coincides with the secrecy level of the current document, the current Rule definition is determined as being the applying Rule definition. On the other hand, if at least one thereof does not coincide, it is determined that the current Rule definition is not the applying Rule definition, and Step S121a-4 is returned to, so that a subsequent Policy definition should be processed instead. For example, when the determination result 1 is ‘person concerned’, and the secrecy level of the current document is ‘confidential’, the Rule definition r1 is determined as being the applying Rule definition since the value of the Subject definition of the Target definition t1 is ‘person concerned’ and the value of the Resource definition is ‘confidential’.

When the current Rule definition is determined as being the applying Rule definition, the access mask module 12 obtains a type of operation to which the current Rule definition is applied based on the Action definition included in the current Target definition, in Step S121a-7. For example, when the Target definition t1 is the current Target definition, ‘perusal’ is obtained as the relevant type of operation. Then, in Step S121a-8, the access mask module 12 determines whether or not the thus-obtained type of operation is already reflected on the access mask. This determination is made for a case where a plurality of Rule definitions have been made redundantly for the same object (actor, resource or operation). In the present example, the value of RuleCombinatingAlg ID attribute is ‘First-applicable’ in the definition of the policy 113 (see description 131-1 of FIG. 7). Therefrom, the first one is applied with a higher priority when a plurality definitions have been made redundantly. Accordingly, when the relevant operation has been already reflected on the access mask, Step S121a-4 is returned to, so that a subsequent Policy definition should be processed then.

On the other hand, when the relevant type of operation has not been reflected on the access mask yet, the access mask generating module 12 carries out determination of permission/denial for the relevant type of operation based on the value of the Effect attribute of the current Rule definition, determination of permission/denial for extension by the permit based on the Overwritable definition, obtains an obligation based on the Obligation definition of the current Policy definition, writes in the access mask the permission/denial of the relevant type of operation (a type of operation will be referred to as an operation type, hereinafter), the permission/denial for extension by the permit, and the contents of the obligation, in Step S121a-9. For example, in a case where the Rule definition r1 is the current Rule definition, the value of the Effect attribute is ‘Permit’. Therefrom, it is determined that perusal operation is permitted. Further, from the value of the Overwritable attribute as being ‘Permit’, it is also determined that extension by the permit is also permitted. Further, from the Obligation definition o1 (AUDIT INFORMATION RECORD), ‘audit information record’ is obtained as the obligation. The thus-obtained items are then written in the access mask. However, the definitions in the policy 113 may be abstract ones for the application 41. For example, it is not clear what specific processing is meant by ‘audit information record’. The access mask generating module 12 solves this problem based on the mapping table 121, replaces such absolute expressions in the policy 113 by specific expressions for the application 41, and writes the thus-replaced specific expressions in the access mask.

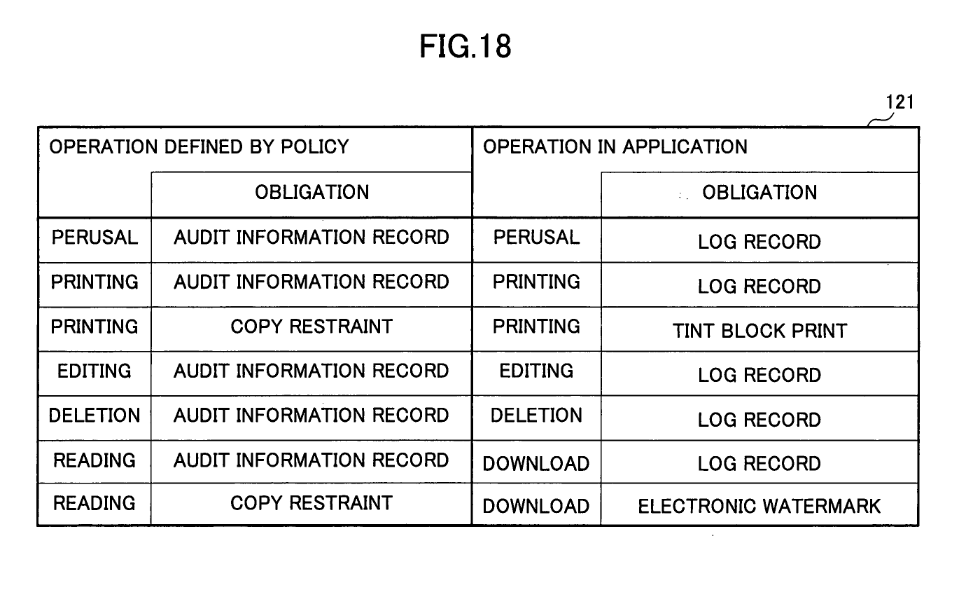

FIG. 18 shows an example of the contents of this mapping table 121. As shown, the mapping table 121 prescribes relationship between expressions of the operation types and the obligations in the policy 113 and corresponding expressions of the operation types and the obligation in the application 41. For example, according to the mapping table 121, the obligation ‘audit information record’ (audit information recording) in the policy 133 is interpreted as being ‘log record’ (log recording) for the application 41. Such a specific interpretation may depend on each particular application, and thus, the mapping table 121 may be prepared for each particular application.

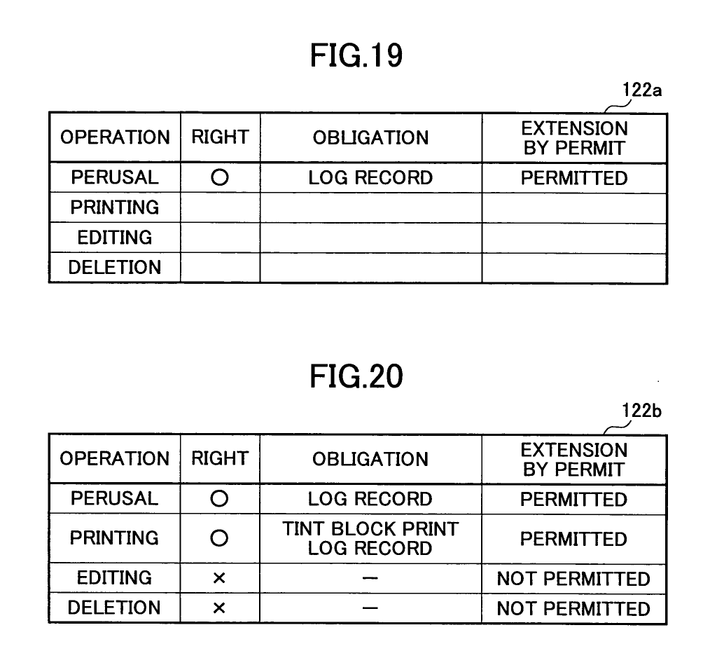

The state of the access mask after Step S121a-9 is first executed is shown in FIG. 19. FIG. 19 shows an example of the access mask on which the definition for one operation type is reflected. In the access mask 122a shown, the definition in the Policy definition p1 is reflected. That is, information is reflected thereon that perusal is permitted; as the obligation therefor, ‘log record’ is set; and extension by the permit is permitted.

In Step S121a-10, the access mask generating module 12 determines whether or not writing in the access mask has been completed for all the operation types (perusal, printing, editing and deletion). When it is determined that all the writing has been finished, the current processing is finished. On the other hand, when some remains to be further reflected on the access mask, Step S121a-4 is returned to so that a subsequent Policy definition is processed then.

When the processing has been finished for all the Policy definitions (No in Step S121a-4), the access mask generating module 12 completes the access mask by writing prescribed values in unfixed parts of the access mask, that is, parts for which clear definitions are not provided by the policy 113, in Step S121a-11. For example, if the editing operation or the deletion operation is not fixed, information is written therefor meaning that ‘a right is not permitted’, ‘no obligation is placed’ and ‘no extension by the permit is permitted’.

FIG. 20 shows one example of the access mask generated by the processing of FIG. 17. This access mask 122b is an access mask for the user A on the respective operation types on the document A.

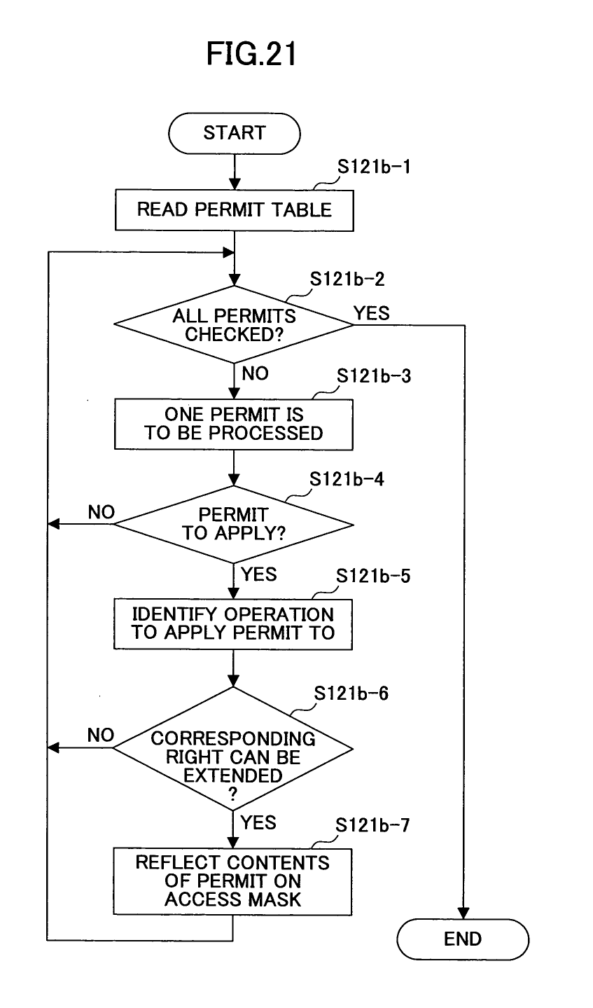

Next, processing (S121b of FIG. 16) of reflecting the contents of the permit in the thus-generated access mask 122b is described. FIG. 21 is a flow chart illustrating the processing of reflecting the contents of the permit in the access mask.

In Step S121b-1, the access mask generating module 12 reads in a memory the contents of the permit table 114 (FIG. 11) obtained from the security management module 11. After that, loop processing for each permit registered in the permit table 114 is carried out (S121b-2). In Step S121b-3, the access mask generating module 12 determines one permit (referred to as a current permit, hereinafter) from among those registered in the permit table 114 in sequence from the top, to process now. In Step S121b-4, the access mask generating module 12 determines based on the user name and the document name written in the current permit whether or not the current permit is one (referred to as an ‘applying permit’, hereinafter) to be applied to the combination between the current user and the current document. Unless the current permit is the applying permit, Step S121b-2 is returned to so that a subsequent permit is then processed instead.

When the current permit is the applying permit, the access mask generating module 12 obtains, based on the additional right written in the permit, an operation type (relevant operation) to which the permit is applied to, in Step S121b-5. In Step S121b-6, the access mask generating module 12 determines, with reference to the access mask 122b (FIG. 20) generated from the process of FIG. 17, whether or not extension by the permit is permitted for the right of the relevant operation. When extension by the permit is not permitted for the right for the relevant operation, it is not possible to reflect the contents of the current permit in the access mask 122b. Accordingly, Step S121b-2 is returned to so that a subsequent permit is processed then.

When extension by the permit is permitted for the right of the relevant operation, the access mask generating module 12 overwrites the information for the relevant operation written in the access mask 122b by the contents of the current permit in Step S121b-7. There, the access mask generating module 12 converts the additional right and the obligation written in the permit into expressions for those of the application 41 based on the mapping module 121 (FIG. 18), and reflects the thus-obtained converted information in the access mask 122b. When the processing on all the permits has been completed (Yes in Step S121b-7), the access mask generating module 12 finishes the current processing.

In the permit table 114 shown in FIG. 11, the permit of the permit ID of ‘3’ (referred to as a ‘permit 3’, hereinafter) is a permit for the combination between the current user (user A) and the current document (document 2) as shown. Further, the permit 3 is a permit for printing operation as shown. Further, according to the access mask 122b, extension by the permit for printing operation is permitted as shown in FIG. 20. Accordingly, through the processing of FIG. 21, the information for printing operation in the access mask 122b is overwritten with the permit 3.

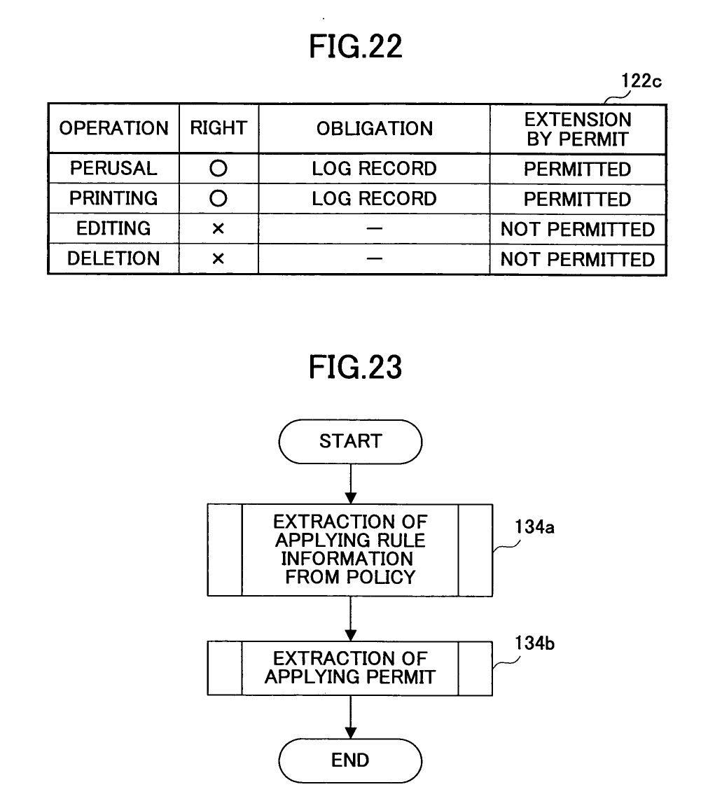

FIG. 22 shows an example of the access mask in which the contents of the permit are reflected. In comparison between the access mask 122c after the reflection of the permit 3 and the access mask 122b before the reflection of the permit 3, it is seen that the obligation is eased in the access mask 122c. This is because, according to the present embodiment, logical product between the obligation set in the policy 113 and the obligation set in the permit is set as the final obligation. However, applying the logical product is merely an example, and, alternatively, it is also possible to apply logical sum or such to be set as a final obligation, depending on each particular application manner. In the above-mentioned example, the printing operation overwritten by the permit 3 is originally permitted also in the policy 113. However, if, unlike this, some operation is not permitted in the policy 113 but is permitted in the permit, permission is set as a final permission/denial value for the right, and the value is reflected in the access mask.

Then, from the access mask 122b, thus generated by the processing described above with reference to FIGS. 17 and 21, unnecessary information, i.e., information of the column of ‘extension by permit’, for the application, is removed. As a result, the access mask 122b is changed into the access mask 122c which is then transmitted to the application 41.

Next, processing of extracting the applying rule information carried out by the applying rule information extracting module 13 in Step S134 of FIG. 13 is described in detail. FIG. 23 shows a flow chart illustrating an outline of the processing of extracting the applying rule information by the applying rule information extracting module 13. As shown, the processing of extracting the applying rule information generally includes processing of extracting the applying rule from the policy 113 (S134a) and processing of extracting the permit (applying permit) from the permit (S134b) for the combination between the current user and the current document. Each thereof is described now.

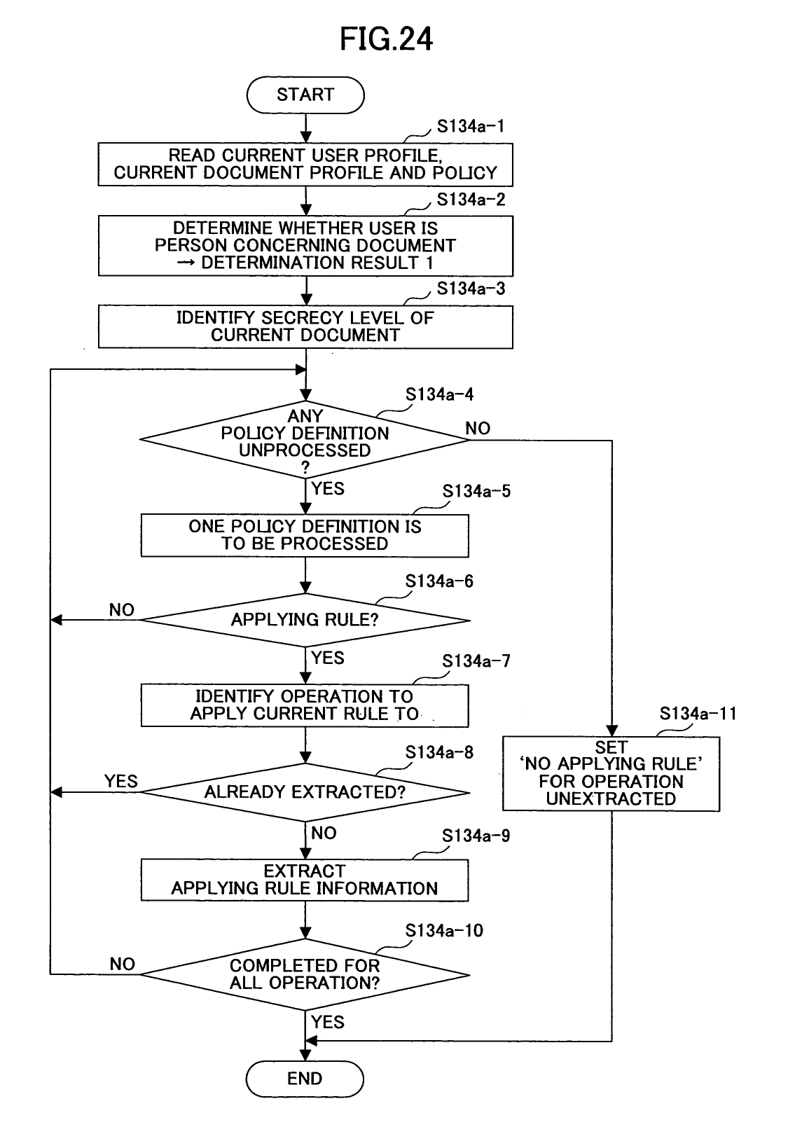

FIG. 24 shows a flow chart of the processing of extracting the applying rule from the policy 113. In FIG. 24, Steps S134a-1 through S134a-8 are the same as the processing (S121a-1 through S121a-8) for determining the applying Rule definition in FIG. 17. That is, the applying rule information extracting module 13 obtains the Rule definition (applying Rule definition) for the combination between the current user and the current document from the policy 113 (S134a-1 through S134a-6), and also, determines an operation type (relevant operation) to which the applying Rule definition is applied (S134a-7). Then, the applying rule information extracting module 13 determines in Step S134a-8 whether or not the applying rule information has been already extracted for the relevant operation (S134a-8).

When the applying rule information has not been extracted for the relevant operation yet, the applying rule information extracting module 13 extracts the policy ID of the Policy definition, the definition content statement and the contents of the obligation, from the definition in the Policy attribute, the Description definition and the Obligation definition, respectively, in Step S134a-9. Further, based on the value of the Overwritable attribute of the applying Rule definition, the applying rule information extracting module 13 determines whether or not extension by the permit is permitted. The policy ID, the definition content statement, the contents of the obligation and the determination result of permission/denial for extension by the permit thus obtained are held as ‘applying rule information’.

Then, in Step S134a-10, the applying rule information extracting module 13 determines whether or not extraction of the applying rule information for all the operation types (perusal, printing, editing and deletion) has been completed. When the processing has been completed, the current processing is finished. When the applying rule information still remains to be further extracted for some operation type, Step S134a-4 is returned to so that a subsequent Policy definition is processed then.

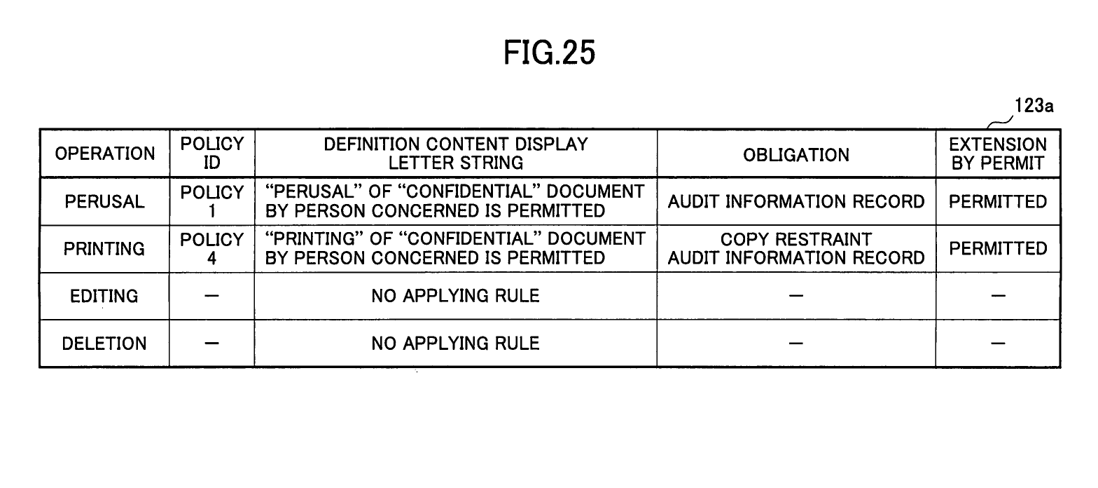

When the processing for all the Policy definitions has been finished (No in S134a-4), the applying rule information extracting module 13 applies a prescribed value as the applying rule information for an operation type for which clear definition is not provided by the policy 113, in Step S134a-11. For example, if the applying rule information for the editing operation or the deletion operation is not fixed, information is written therefor such as ‘no applying rule’ (see FIG. 25).

From the processing described above, information shown in FIG. 25 is extracted. FIG. 25 shows an example of the extracted applying rule information. As shown, in the applying rule information 123a, the policy ID, the definition content statement, the obligation and permission/denial for extension by the permit are shown for each operation type. This applying rule information 123a is one for the combination between the user A and the document 2.

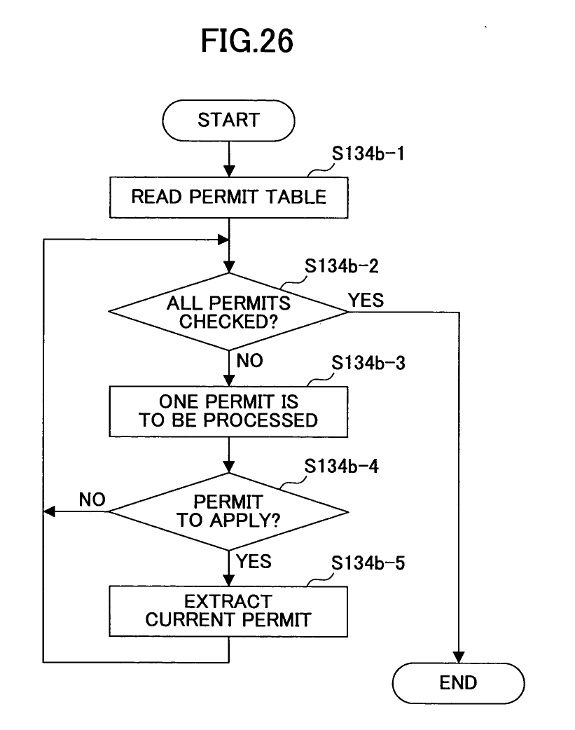

Next, processing of extracting the applying permit from the permit table 114 (S134b of FIG. 23) is described. FIG. 26 is a flow chart illustrating the applying permit extracting processing. In FIG. 26, Steps S134b-1 through 134b-4 are the same as the processing of determining the applying permit (S121b-1 through S121b-4) of FIG. 21. That is, the applying rule information extracting module 13 determines the permit (applying permit) for the combination between the current user and the current document from the permit table 114 (S134b-1 through S134b-4), and extracts the relevant applying permit (S134b-5).

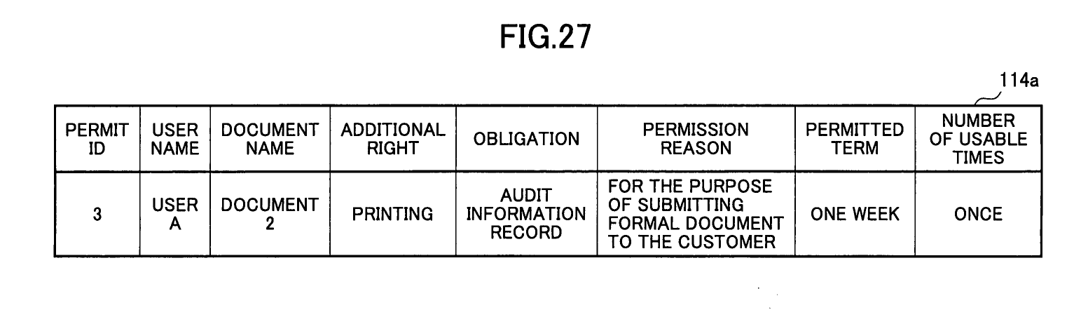

For example, when the user A is the current user and the document 2 is the current document, the permit shown in FIG. 27 is extracted. FIG. 27 shows an example of the extracted permit. As shown, for the applying permit, its permit ID, the user name, the document name, the additional right, the obligation, the permission reason, the permitted term, the number of usable times and so forth are extracted.

The access mask 122c (FIG. 22), the applying rule information 123a (FIG. 25) and the permit 114a (FIG. 27), generated from the processing described above with reference to FIGS. 16 through 26 are transmitted to the application 41 in Steps S122 (FIG. 12) and S135 (FIG. 13). Then, based on the information, the application 41 displays the operation right perusal page 400 (FIG. 15).

As shown in the operation right perusal page of FIG. 15, it is seen that the operation right display area 401 and the obligation display area 402 are displayed based on the access mask 122c; the applying rule display area 403 is displayed based on the applying rule information 123a; and the permit display area 404 is displayed based on the permit 114a.

Next, processing carried out when any operation type is selected by the user from the operation right display area 401 is described. In this case, as a sequence among the respective modules, processing the same as that of FIG. 13 is carried out based on operation of mouse click or such made by the user. That is, based on the selecting operation by the user, the application 41 carries out processing for applying a highlight display manner in the applying rule display area 403 and the permit display area 404 for the applying rule information and the permit corresponding to the thus-selected operation type (referred to as ‘current operation’, hereinafter), respectively. For this purpose, the application 41 requests the applying rule information extracting module 13 for the applying rule information and the applying permit in Step S123. However, in this case, not all the applying rule information and so forth is requested, but only the applying rule information concerning the current operation is requested. Therefore, in this request, in addition to the ticket and the document ID, the operation name for identifying the current operation is also designated as an argument.

After that, processing the same as that described above is executed in Steps S124 through S133. However, in Step S134, the processing of extracting the applying rule information and the processing of extracting the applying permit from the policy are somewhat different from those of FIGS. 24 and 26. Therefore, description is made therefor below.

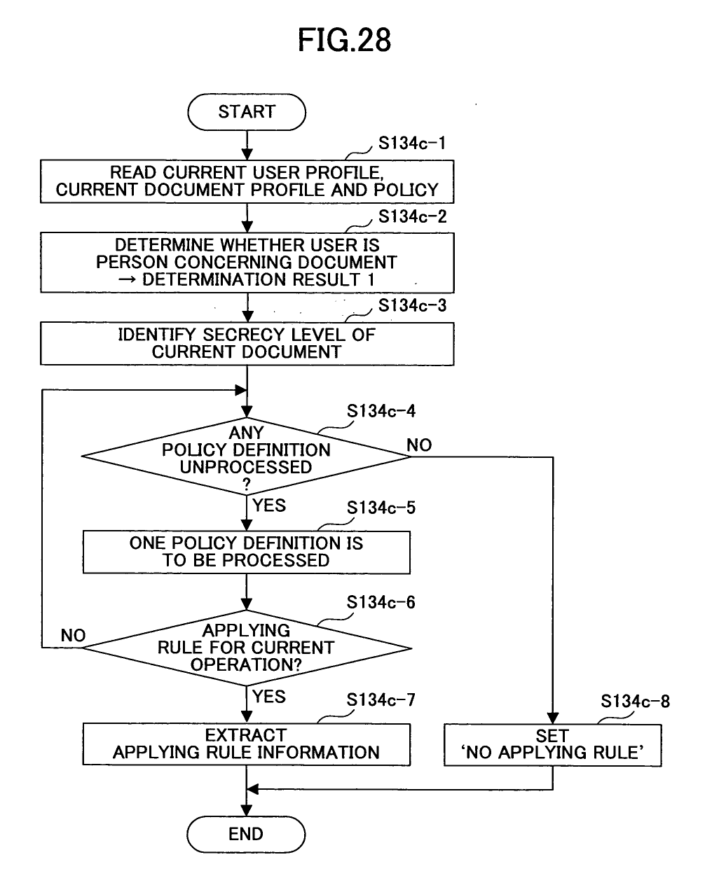

FIG. 28 shows a flow chart illustrating the processing for extracting the applying information for the current operation. in FIG. 28, Steps S134c-1 through S134c-5 are the same as Steps S134a-1 through S134a-5 of FIG. 24. That is, it is determined based on the current user profile and the current document profile whether or not the current user is a person concerning the current document, and also, the secrecy level of the current document is obtained (S134c-1 through S134c-3). Then, one Policy definition (current Policy definition) is determined from the policy 113 to be processed now (S134c-5).

Then, in Step S134c-6, the applying rule information extracting module 13 determines whether or not the Rule definition (current Rule definition) belonging to the current Policy definition is a Rule definition to be applied for the combination between the current user, the current document, and further, the current operation. When it is determined that the current Rule definition is the Rule definition (applying Rule definition) to be applied, the applying rule information extraction module 13 extracting the applying rule information from the current Policy definition, and, in Step S134c-7, finishes the current processing. On the other hand, when it is determined that the current Rule definition is not the applying Rule definition, Step S134c-4 is retuned to so that a subsequent Policy definition is then processed. After the processing for all the Policy definitions has been completed (No in S134c-4), the applying rule information extracting module 13 applies a prescribed value in the applying rule information for the current operation in Step S134c-8. For example, ‘no applying rule’ is set in the definition content statement.

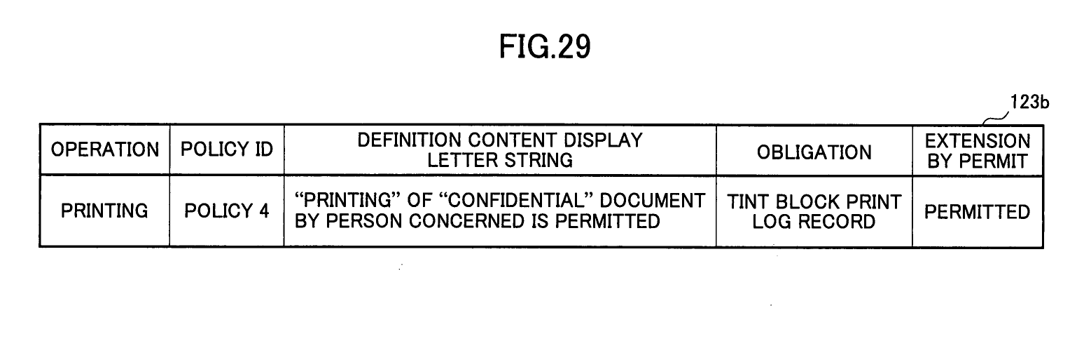

FIG. 29 shows an example of the applying rule information for the current operation. The applying rule information 123b of FIG. 29 is one for a case where the user A is the current user and the document 2 is the current document, and printing operation is the current operation. As shown, only the applying rule for the operation type selected by the user is extracted.

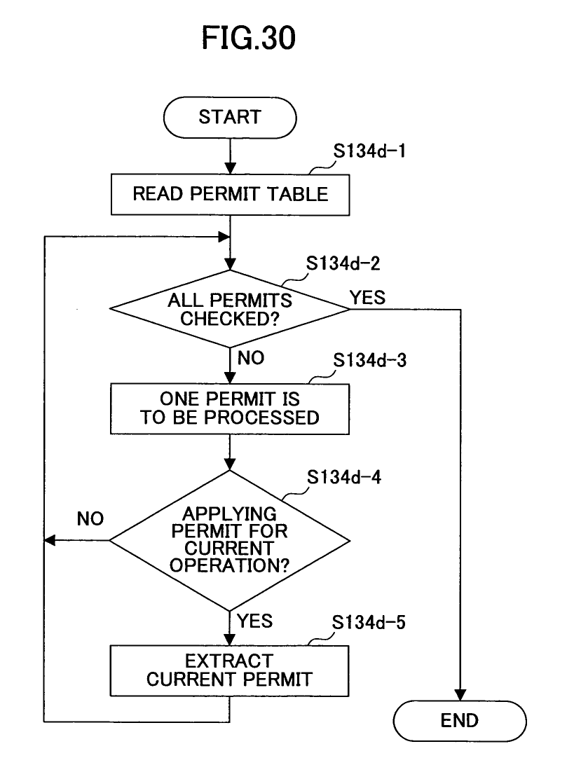

Next, processing of extracting the applying permit for the current operation is described. FIG. 30 shows a flow chart illustrating the processing of extracting the permit for the current operation. The processing of FIG. 30 is the same as the processing of FIG. 26 except Step S134d-4. That is, in FIG. 30, in the determination as to whether or not the current permit is the applying permit, it is determined whether or not the current permit is one for the current operation. It is noted that, the permit extracted for a case where the user A is the current user, the document 2 is the current document and printing operation is the current operation is the same as the permit 114a shown in FIG. 27.

After that, the applying rule information 123b (FIG. 29) and the applying permit 114a (FIG. 27) extracted in the processing of FIGS. 28 and 30 are transmitted to the application 41, which then applies the highlight display manner to the information concerning the current operation based on the applying information 123b, the applying permit 114a and so forth.

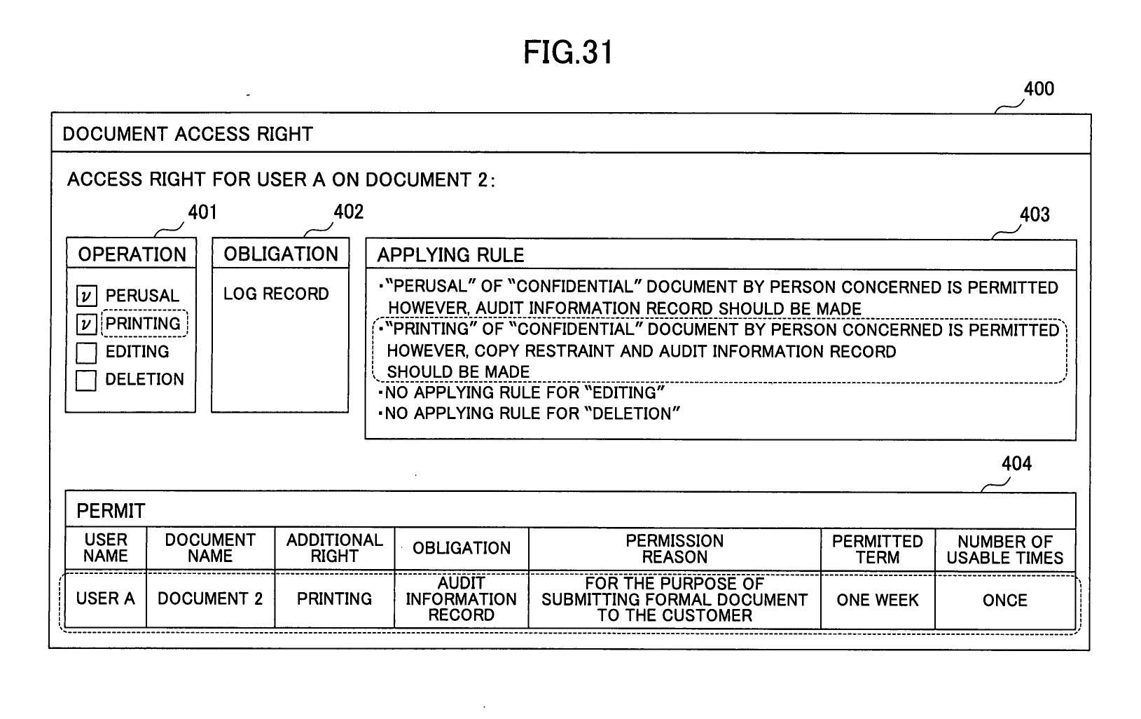

FIG. 31 shows an example of a display of the operation right perusal page when printing operation is selected. In the operation right perusal page 400 of FIG. 31, in the obligation display area 402, an obligation (log record) set for the printing operation is displayed. The information that the obligation set for the printing operation is log record is obtained based on the access mask 122 (FIG. 14) received in Steps S122 (FIG. 12). Further, in the applying rule display area 403 and the permit display area 404, the highlight display manner is applied to the security rule definition contents applied for the printing operation and the applying permit, respectively. Which items the highlight display manner should be applied to in the applying rule display area 403 and the permit display area 404 is determined based on the applying rule information 123b and the applying permit 114a for the current operation received based on the selection of the operation type. That is, each of the policy IDs of the applying rule information already displayed and the policy ID of the applying rule information for the current operation newly received are compared with one another. Thereby, it is possible to determine one corresponding to the current operation. Also, each of the permit IDs of the permits already displayed and the permit ID of the applying permit for the current operation newly received are compared with one another. Thereby, it is possible to determine one corresponding to the current operation. In FIG. 31, application of the highlight display manner is expressed by enclosing with a broken line for the purpose of simplification. However, actually, a display color is changed, a reversing display manner is applied, or such, for achieving the highlight display manner.

Thus, in the operation right perusal page 400, the highlight display manner is applied to the applying rule information or the permit corresponding to the operation type selected from the operation right display area 401. Accordingly, the user can easily understand, not only whether or not an operation right is given from the final determination result shown in the operation right display area 401, but also the foundation of the determination result, that is, why the perusal right or such is given or is not given for the relevant document. Further, the operation name displayed in the operation right display area 401 and the contents of the obligation displayed in the obligation display area 402 are in specific expressions of meaning belonging to the application 41. Accordingly, the user should not make interpretation from abstract definitions in the policy 113 by oneself, but can immediately recognize an operation right given to the user for the application 41.

As described above, in the document management system 1 according to the embodiment of the present invention, it is possible to provide the determination result for permission/denial derived from the combination of the plurality of items of security information in a manner such that a viewer can recognize the contents, thus provided, at a glance. Also, it is possible to display the determination result for access control based on the abstract rule in the specific expression corresponding to the function provided by the specific application. Further, it is possible to explicitly display which rule the determination result is based on. As a result, it is possible to provide the determination result for access control based on the policy 113 in such a manner that the user can easily understand the contents thus provided.

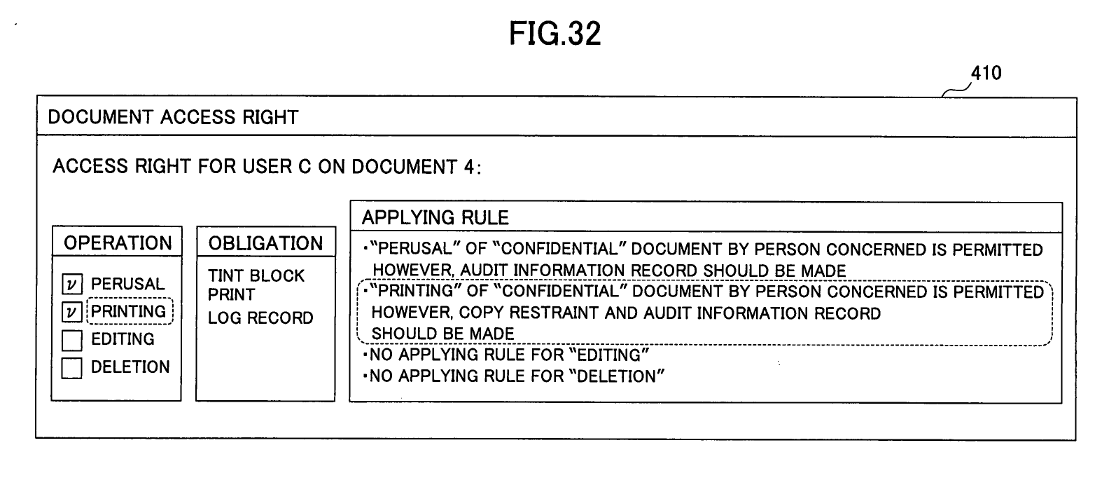

Other examples of display of the operation right perusal page are described below. FIG. 32 shows an example of a display of the operation right perusal page for displaying an operation right for a user C on a document 4. Since no permit is issued for the user C, the permit display area 404 is not included in the operation right perusal page 410 of FIG. 32.

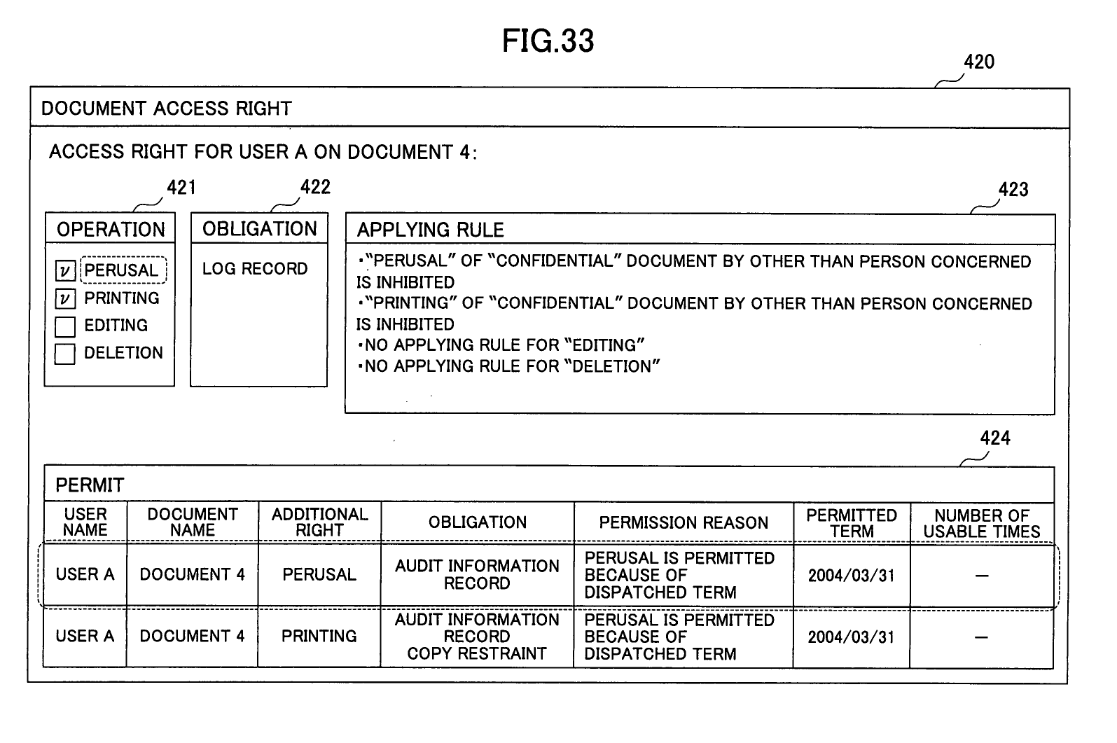

FIG. 33 shows another example of a display of the operation right perusal page for displaying an operation right for the user A on the document 4. In the operation right perusal page 420 shown in FIG. 33, in the applying rule display area 423, it is displayed that ‘“perusal” of “confidential” document by other than person concerned inhibited’. However, in the operation right display area 421, a display is made meaning that perusal operation is permitted. This is because the permit on the first line (on this line, the number of the usable times is not shown) displayed in the permit display area 404 is applied. Therefore, no highlight display manner is applied to the applying rule information, application of which is cancelled by the permit, while the highlight display manner is applied only to the permit, as shown.

Further, the present invention is not limited to the above-described embodiments, and variations and modifications may be made without departing from the basic concept of the present invention claimed below.

The present application is based on Japanese Priority Application No. 2004-114373, filed on, Apr. 8, 2004, the entire contents of which are hereby incorporated herein by reference.

1. An information processing apparatus comprising:
an operation permission/denial information generating part carrying out permission/denial determination for operation of one actor on one resource for each type of operation based on resource classification information classifying each resource to be operated, actor classification information classifying each actor who operates the resource and definition information defining rules concerning permission/denial determination on the operation for each type of operation corresponding to combinations between the resource classifications and the actor classifications; and generating operation permission/denial information indicating permission/denial for each type of the operation based on thus-obtained permission/denial determination result.

2. The information processing apparatus as claimed in claim 1, wherein:
said operation permission/denial information generating part determines the one actor's classification based on the actor classification information; determines the one resource's classification based on the resource classification information; applies the rule from among those defined by the definition information corresponding to the combination between the one actor's classification and the one resource's classification; and carries out the permission/denial determination on the operation to which the corresponding rule is applied.

3. The information processing apparatus as claimed in claim 1, wherein:
said operation permission/denial information generating part responds to the operation permission/denial information providing request from a display device which displays the operation permission/denial information, generates the operation permission/denial information for the combination between the actor designated by the providing request and the resource designated by the providing request, and provides the display device of the thus-obtained operation permission/denial information.

4. The information processing apparatus as claimed in claim 2, wherein:
the definition information comprises a definition of an obligation set on the operation to which the rule is applied; and
said operation permission/denial information generating part includes the obligation information in the operation permission/denial information corresponding to the relevant rule.

5. The information processing apparatus as claimed in claim 1, wherein;
said operation permission/denial information generating part further determines additional operation definition information corresponding to the one actor and the one resource from among those defining types of operation which are additionally permitted for the definition information corresponding to the combinations between the actors and the resources, and overwrites, with the thus-obtained additional operation definition information, the operation permission/denial information.

6. The information processing apparatus as claimed in claim 1, wherein:
said operation permission/denial information generating part includes an operation's display format in the operation permission/denial information for each type of the operation, based on the operation's display format definition information defining the operation's display format for a predetermined application for each type of the operation.

7. The information processing apparatus as claimed in claim 4, wherein:
said operation permission/denial information generating part includes an obligation's display format in the operation permission/denial information for each type of the operation, based on the obligation's display format definition information defining the obligation's display format for a predetermined application corresponding to the obligation.

8. The information processing apparatus as claimed in claim 2, wherein:
the definition information defines a statement describing definition contents of the relevant rule; and
the information processing apparatus further comprises a rule information extracting part generating rule information including the statement for each type of the operation, by extracting the statement corresponding to the rule.

9. The information processing apparatus as claimed in claim 8, wherein:
said rule information extracting part responds to the rule information providing request from the display device which displays the rule information together with the operation permission/denial information, generates the rule information including the statement corresponding to the rule corresponding to the combination of the actor designated by the providing request and the resource designated by the providing request, and provides the thus-obtained rule information to the display device.

10. The information processing apparatus as claimed in claim 8, wherein:
said rule information extracting part extracts the obligation information corresponding to the rule, and includes the thus-obtained obligation information in the rule information in such a manner that the obligation information may relate to the type of the operation to which the rule is applied.

11. The information processing apparatus as claimed in claim 9, wherein:
said rule information extracting part responds to the rule information providing request, extracts additional operation definition information corresponding to the combination between the actor designated by the providing request and the resource designated by the providing request from among those defining types of operation additionally permitted for the definition information corresponding to combinations between the actors and the resources, and provides the thus-obtained additional operation definition information to the display device.

12. The information processing apparatus as claimed in claim 9, wherein:
said rule information extracting part generates the rule information including the statement relating to the rule corresponding to the type of operation when the type of operation is designated in the rule information providing request, and provides the thus-obtained rule information to the display device.

13. The information processing apparatus as claimed in claim 11, wherein:
said rule information extracting part extracts the additional operation definition information corresponding to the type of operation when the type of operation is designated in the rule information providing request, and provides the thus-obtained additional operation definition information to the display device.

14. The information processing apparatus as claimed in claim 1, wherein:
a degree of secrecy is defined for each resource in the resource classification information.

15. The information processing apparatus as claimed in claim 1, wherein:
a relation with an organization which manages the resource is defined for each resource in the resource classification information.

16. The information processing apparatus as claimed in claim 1, wherein:
a relation with an organization which each actor has a predetermined relationship is defined in the resource classification information.

17. The information processing apparatus as claimed in claim 16, wherein:
the definition information defines the rules corresponding to combinations between the resources‘secrecy degrees and whether or not the actors are persons concerned of the resources.

18. The information processing apparatus as claimed in claim 17, wherein:
said operation permission/denial information generating part determines that the actor is a person concerning the resource when the organization which manages the resource and the organization which the actor has a predetermined relationship with agree with one another.

19. The information processing apparatus as claimed in claim 1, wherein:
the definition information is defined based on XACML.

20. An operation permission/denial information generating method for generating operation permission/denial information indicating permission/denial on operation of a resource with the use of a computer, comprising:
an actor classifying identifying step of identifying one actor based on actor classification information classifying each actor who operates the resource;
a resource classifying identifying step of identifying one resource based on resource classification information classifying each resource to be operated;
a permission/denial determining step of carrying out permission/denial determination for each type of the operation by applying a rule corresponding to the one actor's classification and the one resource's classification from among definition information defining the rules for the operation permission/denial for each type of the operation corresponding to combinations between the resources' classifications and the actors' classifications; and
an operation permission/denial information generating step of generating the operation permission/denial information indicating permission/denial for each type of the operation based on the permission/denial determination result.

21. The operation permission/denial information generating method as claimed in claim 20, further comprising:
a permission/denial information request receiving step of receiving the operation permission/denial information providing request from a display device which displays the operation permission/denial information; and
a permission/denial information transmitting step of transmitting the operation permission/denial information generated in said operation permission/denial information generating step to the display device, wherein:
said actor classification identifying step determines the classification for the one actor designated by the permission/denial information providing request; and
said resource classification identifying step determines the classification for the one resource designated by the permission/denial information providing request.

22. The operation permission/denial information generating method as claimed in claim 20, further comprising:
an operation definition information determining step of determining additional operation definition in corresponding to a combination between the one actor and the one resource from among those defining types of operation additionally permitted for the definition information corresponding to the combinations between the actors and the resources; and
an operation definition information reflecting step of overwriting, with the thus-obtained additional operation definition information, the operation permission/denial information generated in said operation permission/denial information generating step.

23. The operation permission/denial information generating method as claimed in claim 20, wherein:
the definition information defines statements describing definition contents of the rules; and
the operation permission/denial information generating method further comprises a rule information generating step of generating rule information including the statement for each type of the operation by extracting the statement relating to the rule from among the definition information.

24. The operation permission/denial information generating method as claimed in claim 23, further comprising:
a rule information request receiving step of receiving the rule information providing request from the display device displaying the rule information together with the operation permission/denial information; and
a rule information transmitting step of transmitting the rule information generated in said rule information extracting step to the display device, wherein:
said rule information extracting step extracts the rule information corresponding to the combination between the actor designated by the rule information providing request and the resource designated by the rule information providing request.

25. The operation permission/denial information generating method as claimed in claim 24, further comprising:
an additional operation definition information extracting step of responding the rule information providing request, and extracting, from among additional operation definition information defining types of operation additionally permitted for the definition information corresponding to the combinations between the actors and the resources, additional operation definition information corresponding to the combination between the actor designated by the providing request and the resource designated by the providing request, and wherein:
said rule information transmitting step further transmits the additional operation definition information extracted by said additional operation definition information extracting step to the display device.

26. A program comprising instructions for causing a computer to execute:
an actor classifying identifying step of identifying one actor based on actor classification information classifying each actor who operates the resource;
a resource classifying identifying step of identifying one resource based on resource classification information classifying each resource to be operated;
a permission/denial determining step of carrying out permission/denial determination for each type of the operation by applying a rule corresponding to the one actor's classification and the one resource's classification from among definition information defining the rules for the operation permission/denial for each type of the operation corresponding to combinations between the resources' classifications and the actors' classifications; and
an operation permission/denial information generating step of generating the operation permission/denial information indicating permission/denial for each type of the operation based on the permission/denial determination result.

27. A computer readable information recording medium recording therein the program claimed in claim 26.
